(19) United States
(12) Patent Application Publication
(10) Pub. No.: US 2026/0333305 A1
(43) Pub. Date: Oct. 22, 2026

(54) ROUTING DATA PACKETS BASED ON TOKEN IMPORTANCE VALUES

(71) Applicant: Lenovo (United States) Inc., Morrisville, NC (US)

(72) Inventors: Joachim Löhr, Wiesbaden (DE); Tapisha Soni, Munich (DE)

(73) Assignee: Lenovo (United States) Inc., Morrisville, NC (US)

(21) Appl. No.: 19/458,122

(22) Filed: Jan. 23, 2026

(51) Int. Cl. H04W 72/04

(52) U.S. Cl. CPC H04W 72/04

(57) ABSTRACT

Various aspects of the present disclosure relate to routing data packets based on token importance values. A user equipment (UE) may receive signaling from a network equipment (NE) that indicates a mapping between a set of logical channels and a set of importance values associated with a set of tokens. The tokens represent data from an application, such as a data processing application. The UE may route a data packet including at least one token of the set of tokens to a logical channel of the set of logical channels based on an importance value associated with the at least one token and the mapping. The NE may receive the data packet via the logical channel based on the importance value and the mapping.

### TECHNICAL FIELD

The present disclosure relates to wireless communications, and more specifically to data packet management.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive signaling that indicates a mapping (e.g., association) between a set of logical channels and a set of importance values associated with a set of tokens, where the set of tokens is associated with an application, and route a data packet including at least one token of the set of tokens to a logical channel of the set of logical channels based on an importance value associated with the at least one token and the mapping.

A processor (e.g., a standalone processor chipset, or a component of a UE) for wireless communication is described. The processor may be configured to, capable of, or operable to perform one or more operations as described herein. For example, the processor may be configured to, capable of, or operable to receive signaling that indicates a mapping between a set of logical channels and a set of importance values associated with a set of tokens, where the set of tokens is associated with an application, and route a data packet including at least one token of the set of tokens to a logical channel of the set of logical channels based on an importance value associated with the at least one token and the mapping.

A method performed or performable by a UE for wireless communication is described. The method may include receiving signaling that indicates a mapping between a set of logical channels and a set of importance values associated with a set of tokens, where the set of tokens is associated with an application, and routing a data packet including at least one token of the set of tokens to a logical channel of the set of logical channels based on an importance value associated with the at least one token and the mapping.

In some implementations of the UE, the processor, and the method described herein, the UE, the processor, and the method may further be configured to, capable of, or operable to obtain (e.g., receive, retrieve, access), from the application, data for input to a tokenizer, and generate (e.g., create, produce, output) a token set based on the data, where the token set includes the at least one token, and where the importance value indicates a semantic relevance of the at least one token for reconstruction of the data. In some implementations, the data packet includes a header that indicates information associated with the token set, and where the information includes one or more of a first sequence number associated with the token set, a second sequence number associated with an initial token in the token set, a third sequence number associated with a final token in the token set, a numerical quantity of tokens within the token set, a numerical quantity of bytes associated with the token set, respective importance values of one or more tokens of the token set, or a minimum numerical quantity of successfully decoded tokens associated with the token set. In some implementations, at least one of the token set or respective tokens of the token set is associated with one or more of a delay budget or a token error rate, and where the token error rate is based on respective importance values of a subset of tokens of the token set. In some implementations, the UE, the processor, and the method may further be configured to, capable of, or operable to transmit a control data packet including metadata associated with the token set, where the metadata includes one or more of respective first sequence numbers corresponding to one or more first tokens of the token set associated with respective importance values that satisfy a threshold importance value, a second sequence number associated with an initial token in the token set, a third sequence number associated with a final token in the token set, a minimum numerical quantity of successfully decoded tokens associated with the token set, or one or more fourth sequence numbers associated with one or more second tokens of the token set corresponding to the token set being successfully decoded.

In some implementations, the UE, the processor, and the method may further be configured to, capable of, or operable to receive additional signaling that indicates to apply, for a radio bearer or at least one logical channel, at least one transmission mode of a set of transmission modes for transmission of a set of data packets including the data packet, where the additional signaling includes a medium access control-control element (MAC-CE). In some implementations, the set of transmission modes includes a first transmission mode that indicates to route the set of data packets to a single logical channel of the set of logical channels and a second transmission mode that indicates to route the set of data packets to the set of logical channels based on the set of importance values. In some implementations, the set of transmission modes includes a transmission mode that indicates to transmit tokens of the set of tokens associated with respective importance values that satisfy a threshold importance value and to discard remaining tokens of the set of tokens. In some implementations, the set of transmission modes includes a transmission mode that indicates to apply a set of discard timers to the set of tokens based on respective importance values associated with the set of tokens.

In some implementations, the UE, the processor, and the method may further be configured to, capable of, or operable to receive additional signaling that enables concatenation of two or more tokens of the set of tokens in the data packet, where the additional signaling includes at least one parameter that indicates that the concatenation is enabled, a token size associated with the concatenation, or a maximum numerical quantity of tokens associated with the concatenation, and multiplex, based on the additional signaling, the two or more tokens in the data packet, where the two or more tokens include the at least one token and are associated with the same importance value. In some implementations, the signaling indicates a range of tags including data packet metadata, where the range of tags is associated with a radio bearer that is mapped to the set of logical channels, and where the data packet is routed within at least one of a packet data convergence protocol (PDCP) layer or a radio link control (RLC) layer. In some implementations, the UE, the processor, and the method may further be configured to, capable of, or operable to transmit an RLC status report that indicates for one or more tokens of the set of tokens to be retransmitted based on a negative acknowledgement (NACK), where the one or more tokens are associated with one or more importance values of the set of importance values that satisfy a threshold importance value.

In some implementations, the UE, the processor, and the method may further be configured to, capable of, or operable to generate a transport block (TB) including the data packet, segment the TB into a set of code blocks (CB), where a CB of the set of CBs includes the at least one token, select, for the set of CBs, one or more respective transmission parameters based on respective importance values associated with tokens within the set of CBs, where the one or more respective transmission parameters include a modulation and coding scheme (MCS), a hybrid automatic repeat request (HARQ) operating point, a maximum numerical quantity of HARQ retransmissions, or an RLC transmission mode, and transmit the TB to an NE based on the one or more respective transmission parameters. In some implementations, the signaling includes radio resource control (RRC) signaling, and where the data packet includes a header that indicates the importance value. In some implementations, the UE, the processor, and the method may further be configured to, capable of, or operable to receive additional signaling that indicates an additional mapping between the set of importance values and a set of maximum transmission and/or retransmission values for an RLC entity, and maintain, for the data packet, a maximum number of RLC transmissions and/or retransmissions based on the importance value and the additional mapping. In some implementations, the additional signaling indicates a radio link failure (RLF) maximum transmission number threshold associated with the RLC entity, and the UE, the processor, and the method may further be configured to, capable of, or operable to trigger an RLF based on an RLC transmission counter satisfying the RLF maximum transmission number threshold.

An NE (e.g., a base station) for wireless communication is described. The NE may be configured to, capable of, or operable to perform one or more operations as described herein. For example, the NE may be configured to, capable of, or operable to transmit signaling that indicates a mapping between a set of logical channels and a set of importance values associated with a set of tokens, where the set of tokens is associated with an application, and receive, via a logical channel of the set of logical channels, a data packet including at least one token of the set of tokens based on an importance value associated with the at least one token and the mapping.

A processor (e.g., a standalone processor chipset, or a component of an NE) for wireless communication is described. The processor may be configured to, capable of, or operable to perform one or more operations as described herein. For example, the processor may be configured to, capable of, or operable to transmit signaling that indicates a mapping between a set of logical channels and a set of importance values associated with a set of tokens, where the set of tokens is associated with an application, and receive, via a logical channel of the set of logical channels, a data packet including at least one token of the set of tokens based on an importance value associated with the at least one token and the mapping.

A method performed or performable by an NE (e.g., a base station) for wireless communication is described. The method may include transmitting signaling that indicates a mapping between a set of logical channels and a set of importance values associated with a set of tokens, where the set of tokens is associated with an application, and receiving, via a logical channel of the set of logical channels, a data packet including at least one token of the set of tokens based on an importance value associated with the at least one token and the mapping.

In some implementations of the NE, the processor, and the method described herein, the NE, the processor, and the method may further be configured to, capable of, or operable to receive a token set including the at least one token, where the token set represents data, and reconstruct the data based on the token set and one or more importance values associated with respective tokens of the token set, where the one or more importance values indicate a semantic relevance of the respective tokens for reconstruction of the data. In some implementations, the data packet includes a header that indicates information associated with the token set, and where the information includes one or more of a first sequence number associated with the token set, a second sequence number associated with an initial token in the token set, a third sequence number associated with a final token in the token set, a numerical quantity of tokens within the token set, a numerical quantity of bytes associated with the token set, the one or more importance values, or a minimum numerical quantity of successfully decoded tokens associated with the token set. In some implementations, at least one of the token set or the respective tokens is associated with one or more of a delay budget or a token error rate, and where the token error rate is based on respective importance values of a subset of tokens of the token set. In some implementations, the NE, the processor, and the method may further be configured to, capable of, or operable to receive a control data packet including metadata associated with the token set, where the metadata includes one or more of respective first sequence numbers corresponding to one or more first tokens of the token set associated with respective importance values that satisfy a threshold importance value, a second sequence number associated with an initial token in the token set, a third sequence number associated with a final token in the token set, a minimum numerical quantity of successfully decoded tokens associated with the token set, or one or more fourth sequence numbers associated with one or more second tokens of the token set corresponding to the token set being successfully decoded.

In some implementations, the NE, the processor, and the method may further be configured to, capable of, or operable to transmit, to a UE, additional signaling that indicates for the UE to apply, for a radio bearer or at least one logical channel, at least one transmission mode of a set of transmission modes for transmission of a set of data packets including the data packet, where the additional signaling includes a MAC-CE. In some implementations, the set of transmission modes includes a first transmission mode that indicates for the UE to route the set of data packets to a single logical channel of the set of logical channels and a second transmission mode that indicates for the UE to route the set of data packets to the set of logical channels based on the set of importance values. In some implementations, the set of transmission modes includes a transmission mode that indicates for the UE to transmit tokens of the set of tokens associated with respective importance values that satisfy a threshold importance value and to discard remaining tokens of the set of tokens. In some implementations, the set of transmission modes includes a transmission mode that indicates for the UE to apply a set of discard timers to the set of tokens based on respective importance values associated with the set of tokens.

In some implementations, the NE, the processor, and the method may further be configured to, capable of, or operable to transmit, to a UE, additional signaling that enables, at the UE, concatenation of two or more tokens of the set of tokens in the data packet, where the additional signaling includes at least one parameter that indicates the concatenation is enabled, a token size associated with the concatenation, or a maximum numerical quantity of tokens associated with the concatenation, and receive, based on the additional signaling, the two or more tokens multiplexed in the data packet, where the two or more tokens include the at least one token and are associated with the importance value. In some implementations, the signaling indicates a range of tags including data packet metadata, where the range of tags is associated with a radio bearer that is mapped to the set of logical channels, and where the data packet is routed within at least one of a PDCP layer or an RLC layer. In some implementations, the NE, the processor, and the method may further be configured to, capable of, or operable to receive an RLC status report that indicates for one or more tokens of the set of tokens to be retransmitted based on a NACK, where the one or more tokens are associated with one or more importance values of the set of importance values that satisfy a threshold importance value.

In some implementations, the NE, the processor, and the method may further be configured to, capable of, or operable to receive, from a UE, a TB including the data packet, where the TB includes a set of CBs associated with one or more respective transmission parameters that are based on respective importance values associated with tokens within the set of CBs, where the one or more respective transmission parameters include an MCS, a HARQ operating point, a maximum numerical quantity of HARQ retransmissions, or an RLC transmission mode. In some implementations, the signaling includes RRC signaling, and where the data packet includes a header that indicates the importance value. In some implementations, the NE, the processor, and the method may further be configured to, capable of, or operable to transmit additional signaling that indicates an additional mapping between the set of importance values and a set of maximum retransmission values for an RLC entity, where the additional signaling indicates an RLF maximum transmission number threshold associated with the RLC entity.

### BRIEF DESCRIPTION OF THE DRAWINGS

FIG. 1 illustrates an example of a wireless communications system in accordance with aspects of the present disclosure.

FIGS. 2 through 4 illustrate examples of transmission diagrams, in accordance with aspects of the present disclosure.

FIG. 5 illustrates an example of a resource diagram, in accordance with aspects of the present disclosure.

FIG. 6 illustrates an example of a signaling diagram, in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of an NE in accordance with aspects of the present disclosure.

FIG. 10 illustrates a flowchart of a method performed by a UE in accordance with aspects of the present disclosure.

FIG. 11 illustrates a flowchart of a method performed by an NE in accordance with aspects of the present disclosure.

### DETAILED DESCRIPTION

In a wireless communications system, a UE and an NE (e.g., a base station, a gNB) may support transmission and reception of signaling, referred to as wireless communication. For example, the UE and the NE may exchange (e.g., transmit and/or receive) data that includes tokens. Tokens may represent a unit of data that corresponds to a word, a sub-word, a character, or another segment of information. A token may have a variable length and captures meaning or context (e.g., semantics) within the data, and may be mapped to embeddings or numerical representations used in artificial intelligence or machine learning applications. A transmitting device, such as a UE, may implement a tokenizer configured to convert source data into a sequence of tokens for transmission over an air interface. A receiving device, such as an NE, may implement a de-tokenizer configured to process the received tokens and reconstruct the original source data based on the tokens and associated importance values. An importance value may be an example metric or measure assigned to a token that indicates the semantic relevance of the token for reconstruction of source data at the application layer. The semantic relevance reflects the degree to which a token contributes to understanding information or context that affects the quality of data reconstruction, where tokens with higher importance values have greater semantic relevance and may be more valuable for preserving the intended meaning or utility of the original source data when processed by a de-tokenizer or application layer decoder.

In some cases, the UE may implement an uplink transmission scheme for allocating time and frequency resources, selecting MCSs, and managing retransmissions. The UE may also implement prioritization schemes to assign relative importance levels to different data flows or packets, which may impact an order in which data is transmitted (e.g., and the resources allocated for the transmissions). In some cases, the uplink transmission and prioritization schemes may be designed to handle data packets of a fixed size, rather than tokens with variable lengths that carry semantic meaning. Additionally, or alternatively, prioritization schemes may not account for a relative importance or contextual relevance of different tokens. Thus, the uplink transmission and prioritization schemes may result in inefficient resource allocation and increased latency for relatively important or contextually relevant tokens due to a lack of semantic awareness in the resource allocation and scheduling processes.

As described herein, to account for a relative importance or contextual relevance of different tokens, a UE receives signaling from an NE that indicates a mapping between a set of logical channels and a set of importance values for a set of tokens. A logical channel refers to a communication channel within a protocol stack with one or more transmission parameters and quality of service (QoS) criterion for routing data packets. The UE obtains data from the application for input to a tokenizer and generates a token set from the data. Each token in the token set has an importance value that indicates a semantic relevance of the token for reconstruction of the data. A token set refers to one or more tokens that may represent the output of a tokenizer for a source signal, such as text, image features, video, or audio. The UE routes a data packet including at least one token (e.g., one or more tokens from the token set or the entire token set) to a logical channel of the set of logical channels. The importance value of the token and the mapping determine the routing. For example, the UE routes high importance tokens (e.g., tokens with greater than a threshold importance value) to logical channels configured with more robust transmission parameters, such as lower-order modulation combined with low code rates. The UE routes low importance tokens (e.g., tokens with less than a threshold importance value) to logical channels configured with higher-order modulation and higher code rates than the logical channels for the high importance tokens. The NE receives the data packet via the logical channel, delivers the data packets after further processing to higher layers, such as an application layer that reconstructs the data using the token set and the importance values of the respective tokens.

By performing the described techniques, a device (e.g., a UE and/or an NE) in a wireless communications system provides improved resource allocation and enhanced transmission efficiency for token-based data communications. Routing tokens to different logical channels according to importance values enables differentiated QoS handling. For example, relatively high value tokens (e.g., tokens with greater than a threshold importance value) are routed to logical channels that are more reliable, while lower-importance tokens (e.g., tokens with less than a threshold importance value) are routed to logical channels with less reliable and higher throughput configurations. Routing tokens according to importance values reduces latency for semantically relevant tokens by prioritizing transmission for tokens with importance values that are greater than (e.g., satisfy, exceed) a threshold value. Routing tokens according to importance values also improves overall wireless communications system capacity by providing for the UE or another transmitting device to transmit less important tokens (e.g., tokens with importance values less than a threshold value) more efficiently or to selectively discard the less important tokens. Additionally, or alternatively, routing tokens according to importance values enables reconstruction of source data at a receiving device even if one or more tokens with importance values less than a threshold value are missing or the receiving device receives the tokens with errors.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth. Further, reference is made herein to a low importance value or token, as well as high importance values or tokens. A low importance value or token may refer to a token with an assigned importance value that satisfies (e.g., is less than) a threshold value. A high importance value or token may refer to a token with an assigned importance value that satisfies (e.g., is greater than, exceeds) a threshold value, which may be the same threshold value as the threshold value for the low importance token or may be a different threshold value from the threshold value for the low importance token.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

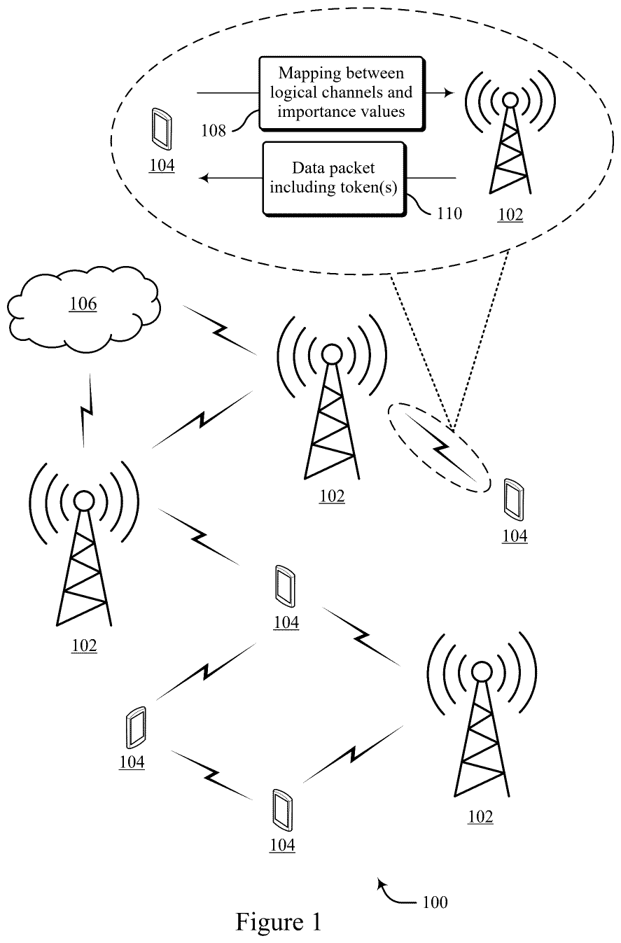

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity may be configured in a disaggregated architecture, which may be configured to utilize a protocol stack physically or logically distributed among two or more network entities, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities in a disaggregated RAN architecture may be co-located, or one or more components of the network entities may be located in distributed locations (e.g., separate physical locations). In some implementations, one or more network entities of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU, such that the CU may support one or more layers of the protocol stack, and the DU may support one or more different layers of the protocol stack. In some implementations, the CU may host upper protocol layer (e.g., a layer 3 (L3), a layer 2 (L2)) functionality and signaling (e.g., RRC), service data adaptation protocol (SDAP), PDCP). The CU may be connected to one or more DUs or RUs, and the one or more DUs or RUs may host lower protocol layers, such as a layer 1 (L1) (e.g., physical (PHY) layer) or an L2 (e.g., RLC layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack, and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities that are in communication via such communication links.

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In the wireless communications system 100, the NEs 102 and the UEs 104 may support extended reality (XR) services and applications. XR may encompass different types of realities, including virtual reality (VR), augmented reality (AR), mixed reality (MR), or any combination thereof. VR may refer to a rendered version of a delivered visual and audio scene. The rendering may mimic the visual and audio sensory stimuli of the real world as naturally as possible to an observer or user as they move within limits that an application defines. In some cases, VR may involve a user wearing a head mounted display to replace the field of view of the user with a simulated visual component, and wearing headphones to provide the user with accompanying audio. Some form of head and motion tracking of the user in VR may enable the simulated visual and audio components to update to ensure that, from the perspective of the user, items and sound sources remain consistent with the movements of the user. In some cases, there may be additional means to interact with the VR simulation. For AR, a user may receive additional information or artificially generated items or content overlaid upon a current environment. The additional information or content may be visual and/or audible, and the observation by the user of a current environment may be direct (e.g., with no intermediate sensing, processing, and rendering) or indirect (e.g., where sensors relay a perception of the environment and may enhance or process the perception). MR may refer to an advanced form of AR, where some virtual elements insert into a physical scene with the intent to provide the illusion that the elements are part of the real scene.

XR may refer to all real-and-virtual combined environments and human-machine interactions that computer technology and wearable devices generate. XR may include representative forms, such as AR, MR, and VR, and the areas interpolated among them. The levels of virtuality may range from partially sensory inputs to fully immersive VR. In some cases, XR may involve the extension of human experiences relating to the senses of existence (e.g., represented by VR) and the acquisition of cognition (e.g., represented by AR). Many XR and cloud gaming use cases exhibit quasi-periodic traffic patterns with possible jitter, featuring high data rates in the downlink direction (e.g., video streams) combined with frequent uplink transmissions (e.g., pose or control updates) and/or uplink video streams. Both downlink and uplink traffic associated with XR and cloud gaming services may be subject to a relatively strict packet delay budget (PDB). A PDB may include a defined time budget for a packet to transmit over the air from an NE 102 to a UE 104. The UE 104 and/or NE 102 measure the delay of the packet incurred in the air interface from the time that the packet arrives at the NE 102 to the time that the packet successfully transfers to the UE 104. The set of anticipated XR and cloud gaming services may vary, and characteristics of the data streams (e.g., video) may change dynamically while the services run over NR. Therefore, additional information on the running services from higher layers, such as QoS flow association, frame-level QoS, protocol data unit (PDU) set-based QoS, or XR-specific QoS, may facilitate informed choices of radio parameters. XR application awareness by the UE 104 and the NE 102 may improve user experience, enhance NR system capacity in supporting XR services, and reduce UE power consumption

In the context of XR and cloud gaming services, the wireless communications system 100 may utilize PDUs for organizing and processing data transmissions. A PDU may be an example of a unit of data that a protocol of a given layer specifies and that includes protocol control information and user data. An application data unit (ADU) or PDU set may represent a smallest unit of data that an application can process independently, such as processing for handling out-of-order traffic data. A PDU set may refer to a group of one or more PDUs carrying the payload of one unit of information that the application level generates, where the PDUs of a PDU set associate with the same PDU set identifier. In some cases, a video frame may include an intra-frame (I-frame), a predictive-frame (P-frame), or may include I-slices and/or P-slices. An I-frame may refer to a video frame that an encoder encodes independently without reference to other frames and that includes complete image information. A P-frame may refer to a video frame that an encoder encodes based on differences from a preceding reference frame. An I-slice may refer to a portion of a video frame that is intra-coded, while a P-slice may refer to a portion of a video frame that is predictively coded. I-frames and I-slices may be more important and larger in size compared to P-frames and P-slices, as I-frames and I-slices may include reference information that decoders use for decoding other frames or slices. Accordingly, a PDU set may include one or more I-slices, P-slices, I-frames, P-frames, or any combination thereof. The composition of a PDU set may vary based on the application criterion and the characteristics of the data that the wireless communications system 100 transmits.

In some cases, a service-oriented design may account for the characteristics of XR traffic to enable more efficient XR service delivery. Such characteristics may include, but are not limited to, variable packet arrival rates, where packets may arrive at rates ranging from 30 to 120 frames per second with associated jitter, among other examples. Jitter may refer to variation in packet arrival times caused by varying frame encoding delay and/or network transfer time, among other factors. In some examples, XR traffic may include packets of variable sizes, with frame types (e.g., B-frames and P-frames) being dependent on reference frames (e.g., I-frames) for decoding. A bidirectional predictive frame (B-frame) may refer to a video frame that an encoder encodes based on differences from both preceding and subsequent reference frames. The design may further consider the presence of multiple concurrent traffic flows in the uplink direction, such as pose data and video scene data. Pose data may refer to information describing the position and orientation of a user or device, which may update rendered content in XR applications. By accounting for the XR-specific traffic characteristics, the service-oriented design may enable more efficient XR service delivery, for example, by satisfying XR service criterion for a greater numerical quantity (e.g., number, amount) of UEs 104 or by facilitating UE power saving.

In some examples, the latency criterion of XR traffic at the RAN side (e.g., the air interface) may be modeled as a PDB. For a packet, the air interface delay may be measured from the time that the packet arrives at the NE 102 to the time that the UE 104 successfully receives the packet. If the delay exceeds a PDB for the packet, then the packet violates the PDB. If the delay falls within the PDB, then the packet is successfully delivered. The value of the PDB may vary for different applications and traffic types. In some cases, the PDB may be in a range of 10 to 20 milliseconds (ms), among other examples, depending on the application.

In some cases, data bursts on the downlink (e.g., a communication link between an NE 102 and a UE 104) may arrive in a quasi-periodic manner (e.g., periodic with jitter). Factors leading to jitter in burst arrival may include varying server render time, encoder time, real-time transport protocol (RTP) packetization time, link characteristics between a server and a gateway, or any combination thereof. In some examples, simulation assumptions for XR evaluation may model downlink traffic arrival jitter using a truncated Gaussian distribution. The truncated Gaussian distribution may have a mean of 0 ms, a standard deviation of 2 ms, and a truncation range of negative 4 ms to positive 4 ms, as a baseline configuration. In some other cases, the truncation range may be negative 5 ms to positive 5 ms.

In some examples, applications may have a delay criterion on a PDU set that a PDB criterion may not adequately translate. A PDU set delay budget (PSDB) refers to a time constraint applied to an entire PDU set, rather than individual packets. For example, if a PSDB is 10 ms, then the PDB may be set to 10 ms in cases where the packets of the PDU set arrive at the wireless communications system 100 at a same time. If the packets are spread out over time, then the NE 102 and/or the UE 104 may measure the PDU set delay budget in terms of the arrival of the first packet of the PDU set or the arrival of the last packet of the PDU set. In either case, a given PSDB may result in different PDB criterion on different packets of the PDU set. Specifying the PSDB to the wireless communications system 100 may enable handling of PDU sets with varying packet arrival times.

In some cases, the wireless communications system 100 may support functionalities for XR services that involve high data rate and low latency communications. XR awareness may rely on QoS flows, PDU sets, data bursts, and traffic assistance information. To enable PDU set-based QoS handling, a session management function (SMF) may provide PDU set QoS parameters to the NE 102 as part of a QoS profile of a QoS flow. The PDU set QoS parameters may include one or more of a PSDB, a PDU set error rate (PSER), or PDU set integrated handling information (PSIHI). The PSDB may represent an upper bound for the duration between a reception time of a first PDU and a time when a receiving entity successfully receives PDUs of a PDU set. A QoS flow may have a corresponding PSDB, and when available, the PSDB may apply to both downlink and uplink and may supersede the PDB of the QoS flow. The PSER may represent an upper bound for a rate of non-congestion related PDU set losses between the RAN and the UE 104. A QoS flow may have one PSER, and when available, the PSER may apply to both downlink and uplink and may supersede a packet error rate (PER) of the QoS flow. In some cases, a receiving entity may consider a PDU set successfully delivered when the receiving entity delivers all PDUs of the PDU set successfully. The PSIHI may indicate whether an application layer utilizes each PDU of a PDU set for utilizing the PDU set. The PDU set QoS parameters may remain common for PDU sets within a QoS flow.

In some examples, a user plane function (UPF) may identify PDUs that belong to PDU sets and may determine PDU set information to send to the NE 102 in a general packet radio service (GPRS) tunneling protocol user plane (GTP-U) header. The PDU set information may include one or more of a PDU set sequence number, an indication of an end PDU of the PDU set, a PDU sequence number within a PDU set, a PDU set size in bytes, or a PDU set importance (PSI) that identifies a relative importance of a PDU set compared to other PDU sets within the same QoS flow.

A CN 106 may also provide traffic assistance information to the NE 102. The CN 106 may provide the traffic assistance information via time-sensitive communication assistance information (TSCAI) for both guaranteed bit rate (GBR) and non-GBR QoS flows. The traffic assistance information may include uplink and/or downlink periodicity, jitter information associated with the downlink periodicity, or an indication of end of data burst in the GTP-U header of a last PDU in downlink. In the uplink, the UE 104 may identify PDU sets and data bursts dynamically, including PSI, based on UE implementation. In some cases, a frame generation rate may determine a packet arrival rate for XR traffic. For example, at a frame rate of 60 frames per second (fps), the average packet arrival periodicity may be approximately 16.6667 ms, which corresponds to the inverse of the frame rate (e.g., 1/60 fps). In some cases, for periodic arrivals without jitter, the arrival time at the NE 102 for a packet may have an index k (where k=1, 2, 3, . . . ) as k/F1000 ms, where F represents the frame generation rate per second.

The periodic packet arrival model may implicitly assume fixed delays from the network side, including fixed video encoding time and fixed network transfer delay. However, in some cases, varying frame encoding delays and network transfer times may introduce jitter in packet arrival times at the NE 102. In some examples, the jitter can be modeled as a random variable added on top of the periodic arrivals. The jitter may follow a truncated Gaussian distribution with statistical parameters, as shown in Table 1. In some cases, the statistical parameters for the jitter model may include a mean value, a standard deviation, and a truncation range that bounds the jitter values to prevent unrealistic arrival time variations.

TABLE 1
Statistical parameters for jitter

| | | Baseline value | Optional value |
|---|---|---|---|
| Parameter | Unit | for evaluation | for evaluation |
| Mean | ms | 0 | |
| Standard deviation | ms | 2 | |
| Truncation range | ms | [−4, 4] | [−5, 5] |

In some cases, an NE 102 may configure the parameter values and frame generation rates to ensure that packet arrivals occur in order. For example, with frame generation rates of 60 or 120 fps, the arrival time of a subsequent packet may be greater than the arrival time of the preceding packet. The periodic arrival model with jitter may express the arrival time for a packet with index k (where k=1, 2, 3, . . . ) as offset+k/F1000+J [ms], where F represents the frame generation rate per second and J represents a random variable capturing jitter. In some cases, the NE 102 may shift the actual traffic arrival timing for each UE 104 by a UE-specific arbitrary offset, which may account for variations in processing delays, network conditions, or other factors associated with individual UEs 104 within the wireless communications system 100.

Signaling between an NE 102 and one or more UEs 104 in the wireless communications system 100 may include various types of traffic, such as traffic for one or more of artificial intelligence applications and services or other data processing applications and services. Artificial intelligence applications and services may include or implement large language models (LLMs), generative artificial intelligence applications or services, natural language processing applications or services, machine translation applications or services, conversational agents, image recognition systems, video analysis platforms, speech recognition services, or recommendation engines, among other examples. The other data processing applications and services may include, but are not limited to, semantic communication systems, content delivery networks with semantic awareness, multimedia streaming services, real-time collaboration platforms, remote rendering applications, cloud gaming services, or distributed computing frameworks that process segmented data units. The traffic for the artificial intelligence or other data processing application and services may exhibit characteristics that differ from other data traffic. For example, the traffic may include token-based data transmissions. Tokens are fundamental units of processing derived from segmenting raw input data, such as text, images, or audio data, using a defined vocabulary or tokenizer. Each token corresponds to a defined sub-word, character, or contextual element within a framework. The rate and efficiency of token processing may directly affect the perceived quality, latency, and utility of services delivered over a network.

In some cases, uplink transmission schemes may be designed to handle data packets of fixed sizes and may implement prioritization schemes that assign relative importance levels to different data flows or packets. A priority may refer to a scheduling order or transmission precedence assigned to data flows or logical channels for resource allocation purposes. An importance value may indicate the semantic relevance or contribution of a token or data unit to the successful reconstruction or interpretation of information at the application layer. The uplink transmission schemes may not account for the variable lengths of tokens or the semantic meaning that tokens carry. Additionally, or alternatively, prioritization schemes may not consider the relative importance or contextual relevance of different tokens for application layer processing. As a result, the transmission and prioritization schemes may lead to inefficient resource allocation and increased latency for tokens that have greater semantic relevance, due to a lack of semantic awareness in the resource allocation and scheduling processes.

According to implementations, one or more of the NEs 102 and the UEs 104 are operable to implement various aspects of the techniques described with reference to the present disclosure. For example, a UE 104 receives signaling that indicates a mapping between logical channels and importance values 108 from an NE 102. The mapping between logical channels and importance values 108 establishes associations between a set of logical channels and a set of importance values for tokens generated using data obtained from an application, such as an artificial intelligence application or a data processing application. The NE 102 may transmit the mapping between logical channels and importance values 108 via RRC signaling or other control signaling. The UE 104 routes a data packet including tokens 110 to a logical channel of the set of logical channels in accordance with the mapping between logical channels and importance values 108. The UE 104 selects the logical channel according to an importance value assigned to the tokens. The data packet including tokens 110 carries one or more tokens that represent semantic units of data, where tokens having higher importance values may be routed to logical channels configured with more robust transmission parameters, and tokens having lower importance values may be routed to logical channels configured with higher throughput configurations. The UE 104 transmits the data packet including tokens 110 to a receiving device (e.g., an NE 102) via the selected logical channel. The receiving device may reconstruct the original data using the received tokens and assigned importance values. For example, an application layer of the end-to-end receiving device may reconstruct the original data.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

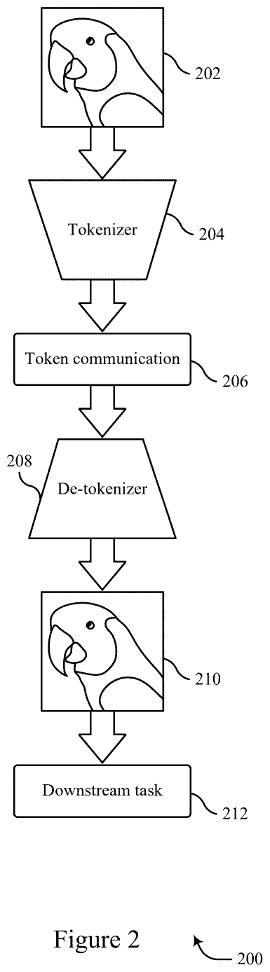

FIG. 2 illustrates an example of a transmission diagram 200 in accordance with aspects of the present disclosure. In some examples, the transmission diagram 200 implements or is implemented by aspects of the wireless communications system 100. For example, the transmission diagram 200 may be implemented by one or more UEs and/or NEs, which may be an example of NEs 102 and UEs 104 as described with reference to FIG. 1. The transmission diagram 200 illustrates an example of a token-based data transmission flow for processing and communicating (e.g., transmitting and/or receiving) information between devices, including the UEs and/or NEs.

In some examples, a transmitting device, such as a UE or an NE, may obtain source data 202 from an application. The source data 202 represents input information to be processed and transmitted. In some cases, the source data 202 may include an image, video, audio, or text, among other example data. The transmitting device provides the source data 202 as input to a tokenizer 204 implemented by the transmitting device to segment raw input data (e.g., the source data 202) into discrete semantic units that encapsulate meaning and/or context.

The tokenizer 204 receives the source data 202 and converts the source data 202 into a sequence of tokens. Each token generated by the tokenizer 204 corresponds to a defined element within the data, such as a word, sub-word, character, or contextual element. In some cases, the transmitting device may implement the tokenizer 204 as a software module that a processor executes, where the processor retrieves tokenization algorithms and vocabulary mappings from a memory component of the transmitting device. For example, the tokenizer 204 operates as part of a signal processing pipeline that receives the source data 202 from an application layer interface and outputs a sequence of tokens for transmission over an air interface. The tokenizer 204 may include a vocabulary lookup table stored in memory that maps input data segments to corresponding token identifiers, where the vocabulary may be pre-trained or dynamically updated based on application criterion. In some cases, the tokenizer 204 implements an algorithm or other sub-word tokenization technique that segments the source data 202 into variable length tokens. The tokenizer 204 interfaces with a digital signal processor (DSP) or similar component to convert tokens into numerical representations for transmission.

In some examples, the tokenizer 204 assigns importance values to generated tokens based on attention weights, entropy measures, or other metrics derived from the tokenization process. The importance values indicate the semantic relevance of each token for reconstruction of the source data 202 at a receiving device. Thus, different tokens may have different importance values based on a semantic relevance for reconstruction of the source data 202. The tokenizer 204 buffers tokens in a transmission queue and provides the tokens to lower protocol layers, such as a PDCP layer or an RLC layer, for encapsulation into data packets and subsequent transmission.

In contrast with communication techniques that treat raw bit streams as the primary unit of communication, tokens serve as discrete semantic or utility carriers aligned with artificial intelligence processing or semantic information outcomes. In the context of LLMs and generative artificial intelligence services central to artificial intelligence integrated 6G networks, tokens represent a fundamental atomic unit of processing, derived from segmenting raw input data (e.g., text, image patches, audio features) using a predefined vocabulary or tokenizer. During both input ingestion and output generation phases, tokens serve as the primary computational currency. A neural architecture of a model (e.g., transformer layers) sequentially processes the tokens to extract semantic meaning, perform reasoning, and produce artificial intelligence generated content. The rate and efficiency of token processing directly governs a perceived quality, latency, and utility of artificial intelligence services delivered over the network. One or more networks (e.g., 4G and/or 5G) may be designed to improve bit throughput and spectral efficiency, whereas token based communication views tokens as units that encapsulate meaning, context, or useful computation (e.g., for artificial intelligence or semantic tasks). The meaning, context, or useful computation may come from LLM vocabularies or other multimodal artificial intelligence processing that maps raw data (text, audio, sensor data) into semantic units. Tokens serve as the native communication currency for communication tasks, reducing redundancy and transmissions and aligning with broader semantic communication research in 6G (e.g., where a wireless communications system delivers value relevant information efficiently for defined tasks). The notion of semantic efficiency is introduced for token-based communication, where tokens carry context and meaning rather than raw data, enabling wireless communications systems to utilize relevant information rather than every bit.

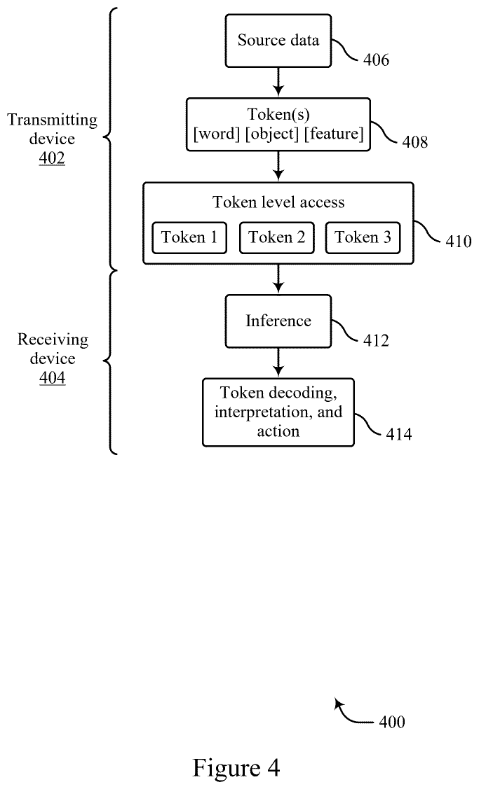

In some examples, the token communication 206 represents the transmission of the token sequence over a communication interface. During the token communication 206, the tokens generated by the tokenizer 204 are transmitted from a transmitting device (e.g., a UE or NE) to a receiving device (e.g., a UE or NE). The token communication 206 may involve routing data packets including tokens to logical channels according to importance values assigned to the tokens, which is described in further detail with respect to FIG. 4. In some cases, relatively high importance tokens (e.g., tokens with importance values that satisfy, exceed, or are greater than a threshold value) may be routed to logical channels configured with more robust transmission parameters. In some other cases, relatively low importance tokens (e.g., tokens with importance values that satisfy or are less than a threshold value) may be routed to logical channels configured with higher throughput configurations. For example, if the token communication 206 includes video data from a video related application, then the transmitting device tokenizes the video data into visual tokens representing objects, individuals, and/or background elements. The transmitting device may transmit the tokens to a receiving device (e.g., an NE). The tokens representing facial features and speech-related visual cues may be examples of relatively high importance tokens, while tokens representing static background elements may be examples of relatively low importance tokens.

The token communication 206 may be an example of token domain multiple access (ToDMA). In ToDMA, devices tokenize source signals (e.g., text, image features) into tokens. Each token is transmitted using a shared codebook and then reconstructed at a receiver. Instead of orthogonal bit slices, the ToDMA scheme manages tokens directly in the multiple-access layer, reducing latency and improving semantic efficiency. Pre-trained models help resolve issues like token collisions by predicting masked or missing tokens.

In some examples, a receiving device receives the tokens and provides them as input to a de-tokenizer 208 to recover the source data 202. The de-tokenizer 208 may refer to a component or algorithm configured to reconstruct the source data 202 based on the received tokens and associated importance values. In some cases, the receiving device may implement the de-tokenizer 208 as a software module that a processor executes, where the processor retrieves de-tokenization algorithms and vocabulary mappings from a memory component of the receiving device. The de-tokenizer 208 operates as part of a signal processing pipeline that receives tokens from lower protocol layers, such as a PDCP layer or an RLC layer, and outputs reconstructed data for delivery to an application layer interface. The de-tokenizer 208 may include a vocabulary lookup table stored in memory that maps received token identifiers to corresponding data segments, where the vocabulary may be pre-trained or dynamically updated based on application criterion and may correspond to the vocabulary used by the tokenizer 204 at the transmitting device. In some cases, the de-tokenizer 208 implements an inverse algorithm or other sub-word reconstruction technique that assembles variable length tokens into coherent data representations. The de-tokenizer 208 interfaces with a DSP or similar component to convert numerical representations of tokens back into an original data format. The de-tokenizer 208 may maintain a token buffer to accumulate received tokens and may utilize sequence numbers associated with the tokens to perform reordering operations before reconstruction. In some examples, the de-tokenizer 208 processes importance values associated with received tokens to prioritize reconstruction of semantically relevant content, enabling the de-tokenizer 208 to generate reconstructed data even when some lower-importance tokens are missing or received with errors.

During the decoding phase, a wireless communications system may be configured to prioritize a successful delivery of high value tokens, where semantic aware transmission schemes are employed as an enabling mechanism. The semantic aware schemes provide for one or more physical layer parameters to be adapted based on semantic metrics (e.g., a token entropy profile), such that tokens conveying more informative or less predictable content receive stronger protection than highly predictable or redundant tokens. High entropy tokens (e.g., novel information in dialog turns) may implement a more robust MCS, such as quadrature phase shift keying (QPSK) with low-rate low-density parity-check (LDPC) codes for ultra-reliable delivery. Low entropy tokens (e.g., conversational fillers) may utilize a less robust MCS, such as 1024 quadrature amplitude modulation (QAM) and high-rate polar codes to maximize token throughput. Token entropy refers to a measure of the information content or unpredictability associated with a token, where high entropy tokens correspond to novel or information rich content and low entropy tokens correspond to predictable or redundant content, such as conversational fillers.

In some examples, the reconstructed data 210 represents the output of the de-tokenizer 208. The reconstructed data 210 corresponds to a recovered version of the source data 202 based on the received tokens. The reconstructed data 210 is then provided to the downstream task 212. For artificial intelligence services supporting content recovery, the criterion is deterministic user experience and service performance, rather than performing consistent reliable data transmission. Artificial intelligence token transmission is a scenario of error tolerant communication.

In some examples, the downstream task 212 represents an application or service that utilizes the reconstructed data 210. The downstream task 212 may include artificial intelligence services, such as classification tasks (e.g., classifying an image into a category, such as an image of a macaw into a bird category), real time translation, context aware recommendations, image recognition, video analysis, or video generation.

Artificial intelligence traffic has one or more unique characteristics (e.g., variable packet sizes, bursty arrival patterns, and latency sensitivity), and tokens are commonly used data units for artificial intelligence application traffic. In some cases, artificial intelligence traffic may exhibit quasi-periodic behavior with jitter, where token sequences arrive in bursts corresponding to inference requests or generation outputs. The traffic patterns may include asymmetric data flows, where uplink transmissions carry input tokens, such as user queries or sensor data, and downlink transmissions carry output tokens, such as generated responses or processed results. In some examples, artificial intelligence traffic may demonstrate temporal correlation, where tokens within a sequence have dependencies that affect reconstruction quality if tokens are lost or delayed. The traffic may also exhibit variable importance distributions, where a subset of tokens carries disproportionately high semantic value relative to the total token count. In some cases, artificial intelligence traffic may include mixed modality content, where text tokens, image tokens, and audio tokens are transmitted within a single session or application context.

The token-based transmission methods accommodate representing, accessing, and transmitting information and go beyond bit-centric transmission methods. For example, instead of treating raw bit streams as the primary unit of communication, tokens as units that encapsulate meaning, context, or useful computation (e.g., for artificial intelligence and/or semantic tasks) are the transmission units considered for the design of the protocol stack and corresponding transmission procedures.

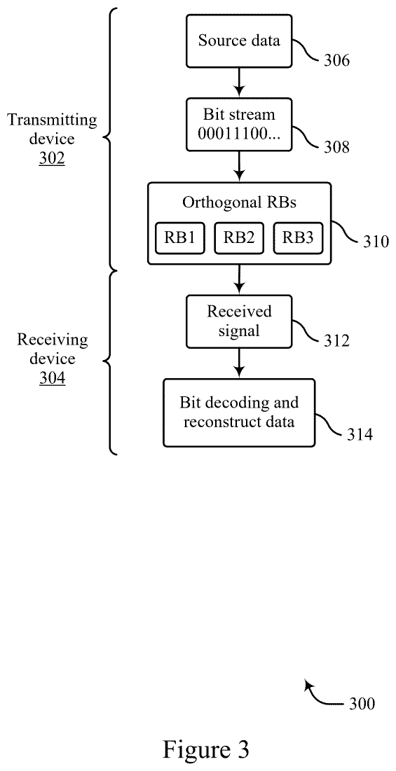

FIG. 3 illustrates an example of a transmission diagram 300 in accordance with aspects of the present disclosure. In some examples, the transmission diagram 300 implements or is implemented by aspects of the wireless communications system 100. For example, the transmission diagram 300 may be implemented by one or more UEs and/or NEs, which may be an example of NEs 102 and UEs 104 as described with reference to FIG. 1. The transmission diagram 300 illustrates an example of a bit-centric data transmission flow for processing and communicating (e.g., transmitting and/or receiving) information between devices, including the UEs and/or NEs.

In some examples, the transmission diagram 300 includes a transmitting device 302 and a receiving device 304. The transmitting device 302 represents a device configured to process and transmit data over a wireless medium. For example, the transmitting device 302 may be a UE, an NE, or another wireless communication device. The receiving device 304 represents a device configured to receive and process transmitted data from the transmitting device 302. For example, the receiving device 304 may be a UE, an NE, or another wireless communication device.

The transmitting device 302 may obtain source data 306. The source data 306 represents original information to be processed and transmitted over the wireless medium. For example, the source data 306 may include an image, video, audio, text, or other data types that the transmitting device 302 prepares for transmission.

The transmitting device 302 converts the source data 306 into a bit stream 308. The bit stream 308 represents a sequence of binary values derived from the source data 306. For example, the bit stream 308 may include a sequence, such as 00011100, where the source data 306 is encoded into binary format for transmission over the air interface.

The transmitting device 302 may map the bit stream 308 onto orthogonal resource blocks (RBs) 310. The orthogonal RBs 310 include one or more RBs used for transmission of the bit stream 308 over the wireless medium. For example, the orthogonal RBs 310 may include multiple RBs, including RB1, RB2, and RB3. Although the transmission diagram 300 illustrates three RBs, the transmission diagram 300 may include any numerical quantity of RBs. Each RB carries a portion of the bit stream 308 using orthogonal frequency division multiplexing (OFDM) or other multiple access techniques.

The receiving device 304 may receive a signal (e.g., the received signal 312) from the transmitting device 302. For example, the received signal 312 may include the data transmitted via the orthogonal RBs 310, which may be subject to channel effects, such as noise, fading, or interference during transmission.

In some examples, the receiving device 304 performs bit decoding and data reconstruction 314 on the received signal 312. The bit decoding and data reconstruction 314 represents the process of recovering the source data 306 from the received signal 312. For example, the bit decoding and data reconstruction 314 may include demodulating the received signal 312, decoding the bit stream, and reconstructing the source data 306 based on the decoded bits.

FIG. 4 illustrates an example of a transmission diagram 400 in accordance with aspects of the present disclosure. In some examples, the transmission diagram 400 implements or is implemented by aspects of the wireless communications system 100 and/or the transmission diagram 200. For example, the transmission diagram 400 may be implemented by one or more UEs and/or NEs, which may be an example of NEs 102 and UEs 104 as described with reference to FIG. 1. The transmission diagram 400 illustrates an example of a token-based data transmission flow for processing and communicating (e.g., transmitting and/or receiving) information between devices, including the UEs and/or NEs.

In some examples, the transmission diagram 400 includes a transmitting device 402 and a receiving device 404. The transmitting device 402 represents a device configured to process and transmit data over a wireless medium. For example, the transmitting device 402 may be a UE, an NE, or another wireless communication device. The receiving device 404 represents a device configured to receive and process transmitted data from the transmitting device 402. For example, the receiving device 404 may be a UE, an NE, or another wireless communication device.

The transmitting device 402 may obtain source data 406. The source data 406 represents original information to be processed and transmitted over the wireless medium. For example, the source data 406 may include an image, video, audio, text, or other data types that the transmitting device 402 prepares for transmission.

The transmitting device 402 converts the source data 406 into tokens 408. The tokens 408 represent discrete semantic units derived from the source data 406. For example, the tokens 408 may include word tokens, object tokens, or feature tokens, depending on the type of source data 406 being processed. Each token of the tokens 408 corresponds to an element within the data, such as a word, sub-word, character, or contextual element.

The transmitting device 402 may provide the tokens 408 to token level access 410. The token level access 410 represents individual tokens, including Token 1, Token 2, and Token 3, which are discrete semantic units derived from the source data 406. Although the transmission diagram 400 is illustrated as including three tokens, the transmission diagram 400 may include any numerical quantity of tokens. The token level access 410 enables transmission of individual tokens over the wireless medium to the receiving device 404.

The receiving device 404 may receive the tokens from the token level access 410 and provide them to a component of the receiving device 404 (e.g., inference engine) for inference 412. The inference 412 represents processing performed using artificial intelligence or machine learning models to extract semantic meaning from the received tokens. For example, the inference 412 may utilize neural network architectures to interpret the tokens and determine semantic content.

In some examples, the receiving device 404 performs token decoding, interpretation, and action 414 on the output of the inference 412. The token decoding, interpretation, and action 414 represents the process of reconstructing the original information from the tokens and performing subsequent operations based on the decoded content. For example, the token decoding, interpretation, and action 414 may include feeding the recovered information into an artificial intelligence service for tasks, such as classification, where an image may be classified into a category based on the decoded tokens.

In some cases, the transmitting device 402 may indicate the importance value of the tokens 408 to enable the receiving device 404 to prioritize processing and reconstruction of semantically relevant content. For example, the transmitting device 402 may extend a Layer 2 (L2) protocol header to include, among other fields, an explicit indicator of the importance value of a corresponding L2 PDU and/or of service data units (SDUs), such as tokens 408, encapsulated within that PDU. An SDU may refer to a unit of data that a protocol layer receives from a higher layer for processing and transmission, where the SDU becomes encapsulated within a PDU at the protocol layer. The L2 protocol refers to a data link layer protocol within the protocol stack, such as the PDCP layer, the RLC layer, or the MAC layer, that handles framing, addressing, and error control for data transmission over the air interface. In some cases, the L2 protocol is the PDCP layer and the L2 PDU is a PDCP PDU. The importance field may represent the relative semantic importance or value of a PDCP PDU or PDCP SDU from the perspective of the application layer or the de-tokenizer 208, acknowledging that different tokens may have different impact on user experience, with some tokens being more high importance than others for application processing.

The transmitting device 402 may configure the PDCP header to carry token related information, for example metadata associated with individual tokens. In some cases, an NE may transmit control signaling, such as RRC signaling, to the transmitting device 402 that configures the transmitting device 402 to include the token related information in the PDCP header. The metadata may include, but is not limited to, an importance value or level and/or dependency information. The dependency information may indicate relationships between tokens, such as whether a token depends on the successful reception of other tokens for proper decoding or interpretation at the application layer. In some cases, the receiving device 404 utilizes the token related information to enable enhanced processing at L2. For example, the receiving device 404 exploits the importance and/or dependency information through a reordering functionality, such that the receiving device 404 forwards tokens or PDUs or SDUs having a high importance level to higher layers even when tokens, PDUs, or SDUs with lower sequence numbers are missing or are still being transmitted. Token related information, such as importance, dependency, or metadata information, provides for controlled out-of-order delivery to minimize application impact when there are PDCP PDU or SDU gaps or losses, improving perceived quality for high importance content.

In some examples, the transmitting device 402 populates the L2 protocol header information, including the importance value field, based on one or more defined (e.g., configured, preconfigured) rules. For uplink transmission, an NE may configure a UE (e.g., the transmitting device 402) with rules for setting the token related information in the L2 protocol header via RRC signaling or other control signaling, such as through dedicated parameters or fields that indicate the mapping rules and header field configurations. The UE may receive a mapping rule from a network element or node (e.g., an NE 102) via control signaling (e.g., RRC signaling or NAS signaling) that associates token importance values with the L2 protocol importance field. The application layer may determine token importance and make the token importance available to the L2 protocol, such as the PDCP or RLC layer, based on a UE implementation (e.g., via interaction between the application layer and the access stratum). The access stratum refers to the functional layer in the UE protocol architecture that handles radio protocols and procedures for communication over the air interface. The L2 protocol then maps the token importance, such as the token-associated metadata as determined by the UE implementation, to the L2 protocol header field according to the configured mapping rules.

In some cases, the numerical quantity (e.g., number, amount) of importance levels or values defined at the application layer and the number of importance levels signaled at L2 may differ. For example, the application layer may associate a larger number of importance levels (e.g., 256) with tokens 408, while the corresponding L2 protocol may support a smaller number of importance levels or values (e.g., 8). The transmitting device 402 maps multiple application layer importance levels onto a reduced set of L2 importance categories. The mapping enables efficient signaling of importance information within the constraints of the L2 protocol header, while preserving the relative ordering of token importance for transmission and processing decisions.

In some cases, the transmitting device 402 may encapsulate multiple tokens of the tokens 408 within a single PDU. For example, the transmitting device 402 may multiplex multiple SDUs, each of them including a token, into one PDU. The transmitting device 402 may determine how many tokens to include in a PDU based on one or more of a size of individual tokens, a configured maximum PDU size, or importance values associated with the tokens 408, among other examples. The concatenation of tokens may follow one or more rules, such as defining which tokens to concatenate. In some examples, the transmitting device 402 may concatenate tokens that share the same importance value into a single PDU, which may reduce overhead and improve transmission efficiency. Thus, the transmitting device 402 may not concatenate PDCP SDUs having an associated different importance value. In some other examples, the transmitting device 402 may receive configuration parameters from an NE via RRC signaling or other control signaling (e.g., NAS signaling), that indicate a maximum numerical quantity of tokens for a single PDU or a reference TB size that the transmitting device 402 uses to determine how many tokens to concatenate. The transmitting device 402 may also consider buffer status and logical channel prioritization when determining the number of tokens to encapsulate in a PDU. In some other examples, the transmitting device 402 concatenates PDCP SDUs which belong to a same PDU set. In some other examples, the transmitting device 402 concatenates PDCP SDUs which belong to a same token set. The transmitting device 402 performs PDCP concatenation of PDCP SDUs based at least on the metadata associated with a PDCP SDU, such as token related information like importance or dependency information.

In some examples, an NE configures a UE (e.g., the transmitting device 402) via RRC signaling or other control signaling to indicate whether PDCP concatenation is enabled for a PDCP entity or radio bearer. In some examples, a new information element (IE) in the PDCP-Config 1E configures the PDCP related configurations and parameters. For example, the new IE configures the UE 104 with a reference uplink grant size or TB size via a field or parameter within an RRC configuration. In some cases, the NE may dynamically update the concatenation parameters via a MAC-CE, such as a token concatenation activation or deactivation MAC-CE, that enables or disables concatenation or adjusts the reference TB size without RRC reconfiguration. A PDCP transmitting entity that is enabled for PDCP concatenation uses the reference uplink grant size or TB size to determine the number of PDCP SDUs to concatenate. The PDCP transmitting entity or UE 104 determines the concatenation parameters based on the configured reference uplink grant, the logical channel prioritization (LCP) status, and the buffer status. The LCP status includes bucket related status of one or more corresponding logical channels, such as Bⱼ, of the corresponding logical channels associated with the PDCP entity. The buffer status indicates data available for transmission or retransmission. The concatenation parameters include how many PDCP SDUs to concatenate or the PDCP PDU size. The PDCP transmitting entity avoids concatenating PDCP SDUs where the resulting PDCP PDU would be segmented later during the TB generation procedure. The segmentation may occur because the uplink grant size is too small or the uplink resources allocated during the LCP procedure to the PDCP transmitting entity or logical channel is smaller than the PDCP PDU size.

In some cases, the NE configures a PDCP SDU size in bytes via RRC signaling or other control signaling, which the UE (e.g., the transmitting device 402) uses to determine whether to concatenate a PDCP SDU. The UE concatenates PDCP SDUs that have a size smaller than the configured threshold. In some other cases, the NE configures a maximum numerical quantity (e.g., number, amount) of tokens that the UE 104 concatenates into one PDCP PDU via RRC signaling or other control signaling. Additionally, or alternatively, the NE may indicate the maximum numerical quantity of tokens via DCI, such as through a dedicated field in a DCI format scheduling an uplink grant, enabling dynamic adjustment of the concatenation based on current channel conditions or scheduling. The configuration parameters enable the NE to control the concatenation behavior based on network conditions, application criterion, and the characteristics of the token-based traffic being transmitted.

A token size may be relatively small, as shown in Table 2. Therefore, for processing complexity, as well as overhead, the transmitting device 402 may concatenate multiple small Internet Protocol (IP) packets (e.g., PDCP SDUs) into one PDCP PDU.

TABLE 2
Example token size

| Token type | Payload Size | Error rate | Scenario |
|---|---|---|---|
| Video | 400 bits per token, | 0.1% for | Realtime |
| | 500 tokens per | important | video |
| | video frame | tokens. | processing |
| Image | 12 bit per token, | 20% for | The picture |
| | 256 tokens | other tokens | in ImageNet |
| | per image | | data set |
| Text | 8-24 bits per | 0.1% for | Human-chatbot |
| | token | all tokens | communication |

NOTE:
The token sizes in Table 2 are examples. The token size may vary for different scenarios.

The concatenation may follow the defined rules to reduce or prevent impacting a perceived QoS. As the transmitting device 402 transmits tokens 408 within a PDCP PDU and a TB with a same uplink transmission parameter (e.g., MCS) over the air interface, the transmitting device 402 may multiplex tokens having similar or a same QoS criterion or semantic value in one PDCP PDU or TB. The QoS criterion may include, but is not limited to, a delay budget, a packet error rate, a token error rate, a priority level, a guaranteed bit rate, a maximum bit rate, a jitter tolerance, or a reliability target. In some cases, the QoS criterion may also include a PDB, a PSDB, or a PSER. Additionally, or alternatively, the QoS criterion may include latency criterion, throughput criterion, or loss tolerance thresholds associated with the tokens or token sets being transmitted. In some examples, each PDCP SDU that arrives from a higher layer (e.g., SDAP layer) to the PDCP layer includes one token 408. As shown in Table 2, the PDCP SDU may have a relatively small size, which results in multiple small PDCP SDUs arriving at the PDCP layer for a token-based transmission. In some examples, a single PDCP SDU may include multiple tokens (e.g., a higher layer above the PDCP layer performs concatenation of tokens). In some examples, the higher layer concatenates a defined (e.g., configured, preconfigured, predefined) numerical quantity of tokens into one packet before delivery to the access stratum.

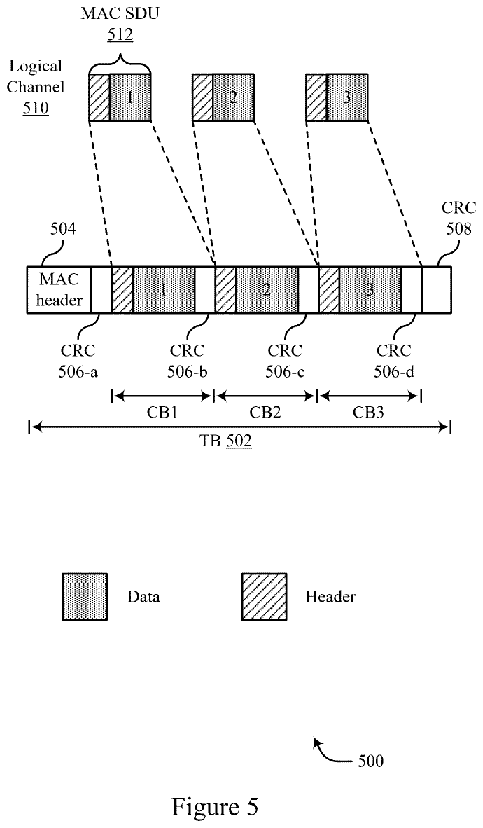

FIG. 5 illustrates an example of a resource diagram 500 in accordance with aspects of the present disclosure. In some examples, the resource diagram 500 implements or is implemented by aspects of the wireless communications system 100, the transmission diagram 200, and/or the transmission diagram 400. For example, the resource diagram 500 may be implemented by one or more UEs and/or NEs, which may be an example of NEs 102 and UEs 104 as described with reference to FIG. 1. The resource diagram 500 illustrates an example of a TB generation and segmentation process for token-based data transmission.

In some wireless communications systems, a transmitting device may apply a single MCS across a MAC PDU or TB 502. The data multiplexed into a TB 502 or a MAC PDU may receive a same QoS treatment, even if the data of different logical channels or PDUs of one logical channel have different semantic importance and different QoS criterion. The NE assigns the MCS in the DCI or uplink grant. However, the NE may not be aware of an up-to-date buffer status at the UE, so the MCS selected by the NE may not accurately address the QoS criterion of the data of the logical channels being multiplexed onto the allocated uplink resources. For example, the NE may not be able to precisely predict the outcome of a logical channel prioritization procedure and may not be aware of the data multiplexed in a MAC PDU or a TB 502.

To enable differentiated QoS handling for tokens with varying semantic importance within a TB 502, a transmitting device may generate and segment a TB 502 according to the importance values of individual tokens. Generating a TB 502 according to the importance values of the tokens enables more granular control over transmission parameters at a CB level, where a CB is a segment of a TB 502 that a transmitting device provides as input to a channel encoder for encoding and transmission. Each CB may be independently encoded and decoded at a receiving device. The TB 502 may include a portion that does not consider the CRC attached to the complete TB 502, which may be referred to as a TB without CRC. The TB 502 may include a MAC header 504, CRC bits 506-a through CRC bits 506-d, one or more CBs (e.g., CB1, CB2, and CB3), and CRC bits 508. The CRC bits 508 may be the CRC attached to the complete TB 502. The transmitting device may map tokens included in the CBs to a logical channel 510, where a CB includes data (e.g., the tokens) and a header. A CB may include a MAC SDU 512 and a corresponding CRC.

In some cases, the MAC header 504 includes control information for the TB 502, including fields that identify one or more logical channels 510 from which the MAC SDUs 512 originate, length indicators for the MAC SDUs 512, and/or other control fields that enable the receiving device to parse and process the TB 502. In some cases, the MAC header 504 may include subheaders corresponding to each MAC SDU 512 within the TB 502, where each subheader indicates a logical channel identifier (e.g., an identifier of the logical channel 510) and a length field for the associated MAC SDU 512. The MAC header 504 may also include padding indicators or other control elements that facilitate alignment and processing of the TB 502 at the receiving device. The MAC header 504 may carry information that enables the receiving device to identify the tokens included within the MAC SDUs 512 and associated importance values, which the receiving device may use for prioritized processing and reconstruction of the transmitted data.

In some examples, the transmitting device separately encodes the MAC header 504 and attaches one or more CRC bits. Encoding the MAC header 504 separately provides for the transmitting device to transmit the control information for parsing of the content of the TB 502. The receiving device utilizes the MAC header 504 to enable parsing of a TB 502 and delivery of CBs to higher layers (e.g., even for cases when the receiving device did not successfully decode the complete TB 502). In some examples, the transmitting device uses a robust (e.g., or low MCS) for the CB carrying the MAC header 504 or header information for parsing the CBs or MAC SDUs 512 (e.g., to ensure the receiving device successfully receives the MAC header 504). A low or robust MCS may refer to an MCS that prioritizes reliability over throughput. In some cases, a robust MCS may utilize a lower-order modulation, such as QPSK, combined with a low code rate, which increases redundancy in the transmitted signal. The increased redundancy may enable the receiving device to successfully decode the transmitted data even in the presence of channel impairments, such as noise, interference, or fading. In some cases, the transmitting device uses a robust MCS for one or more high importance CBs (e.g., CBs carrying high importance data or MAC SDUs, including MAC-CEs or high importance higher layer data).

In some other examples, the transmitting device encodes the MAC header 504 together with the first MAC SDU 512 or token. In some other examples, the transmitting device generates a new header at a MAC or a PHY layer that carries CB related control information. Generating a new header enables a receiving device to decode individual CBs separately. For example, the new header may include fields, such as a CB index, a CB size indicator, an importance value of the CB, or a logical channel identifier corresponding to the data within the CB. In some cases, the new header may be encoded in a separate CB with a CB-level CRC attached that enables the receiving device to verify the integrity of CB carrying the new header information (e.g., CB related control information). The receiving device may utilize the CB control information in the new header to determine whether to forward a successfully decoded CB to higher layers (e.g., based on the MAC header 504 that carries the logical channel identifier information for delivery of a CB to the corresponding RLC entity), even when other CBs within a same TB fail decoding. In some examples, the new header may be transmitted using a more robust MCS than the CBs including user data, which may increase the likelihood that the receiving device successfully receives the CB control information. The new header may be positioned at the beginning of the TB 502 or may be distributed across the TB 502, with portions of the header preceding each CB to provide localized control information for the subsequent CB.

In some examples, a CRC may be an example of an error detection code that a transmitting device appends to data to enable a receiving device to detect errors introduced during transmission. The transmitting device computes one or more CRC bits for the CRC bits 506-a through the CRC bits 506-d and/or for the CRC bits 508 using the contents of the data and an algorithm, and the receiving device performs the same computation on the received data to verify data integrity. In some cases, the transmitting device may generate the TB without attaching a CRC to the complete TB 502 as an intermediate structure during the construction and encoding process of the TB 502. The transmitting device may assemble the MAC header 504 and MAC SDUs 512 before computing and appending the CRC bits 508. The TB 502 may also facilitate segmentation into CBs, where the transmitting device may append individual CRC bits 506-a through CRC bits 506-d to each CB in addition to, or as an alternative to, the entire TB, enabling independent error detection at the CB level. Thus, the CRC bits 506-a through the CRC bits 506-d may provide error detection at the individual CB level to enable selective retransmission or processing of CBs, while the CRC bits 508 may provide error detection for the entire TB 502 to verify overall data integrity across the CBs within the TB 502. To enable the delivery of successfully received or decoded tokens to higher layers for cases when the receiving device did not correctly decode the complete TB (e.g., HARQ failure for the TB), the transmitting device attaches a CRC to every CB, which provides for the receiving device to determine whether a CB was successfully decoded or not.

In some examples, a new MAC-CE is introduced that carries a message authentication code for integrity (MAC-I) to ensure integrity protection and authenticity of defined MAC control information. The integrity protection is configured such that, if the protected message (e.g., one or more MAC-CEs) is modified or tampered with during transmission, the MAC-I verification at the receiving entity fails and the corresponding (e.g., potentially rogue) MAC-CEs are not executed.

In some cases, the MAC-I MAC CE is triggered and/or generated when a TB 502 includes at least one MAC-CE that is configured to utilize lower layer security (e.g., MAC layer integrity protection). An NE may configure a UE with a list of MAC-CEs or one or more types of MAC-CEs that utilize the lower layer security. As long as at least one MAC-CE from this list is multiplexed into a TB 502, the UE also generates a MAC-I MAC-CE to provide integrity and authenticity for the protected MAC-CEs. In some examples, a single MAC-I is calculated to cover all MAC-CEs within the TB 502 that are configured with lower layer security.

In some examples, a transmitter forms a single message by concatenating one or more relevant MAC-CEs (e.g., all relevant MAC-CEs) into a single bit string and computes the MAC-I over this bit string. The integrity protection algorithm uses the bit string together with additional input parameters (e.g., security keys, counters, and identifiers) to compute the MAC-I value. During an LCP and TB generation procedure, the UE reserves uplink resources within the TB for the MAC-I MAC CE whenever at least one MAC-CE utilizing lower layer security is present. If there are insufficient uplink resources in the TB to additionally transmit the MAC-I MAC CE, then the UE may refrain from multiplexing the corresponding MAC-CEs that utilize lower layer security into that TB, thereby ensuring that the MAC-CEs are not transmitted without the associated integrity protection.

In some examples, the logical channel 510 represents a communication channel within the protocol stack that the transmitting device uses to route data packets based on associated transmission parameters and QoS criterion. The logical channel 510 may have one or more characteristics that determine how the transmitting device handles data packets during transmission, including priority levels, scheduling configurations, and reliability targets, among other examples. The transmitting device may map tokens to different logical channels according to the importance values of the tokens. The transmitting device may route tokens with higher importance values to logical channels configured with more robust transmission parameters, and may route tokens with lower importance values to logical channels configured with higher throughput configurations. The logical channel 510 provides a mechanism for differentiating the treatment of tokens during the TB generation and transmission process, enabling semantic aware handling of data at the MAC layer.

In some examples, the MAC SDU 512 represents a unit of data that the MAC layer receives from a higher layer, such as the RLC layer, for encapsulation into a MAC PDU and subsequent transmission within the TB. Each MAC SDU 512 may include one or more tokens, as well as associated metadata (e.g., importance values or sequence numbers) that the receiving device uses for processing and reconstruction of the transmitted data. The MAC SDU 512 may have a variable size depending on the number of tokens encapsulated and the concatenation rules applied at higher layers. In some cases, the MAC layer multiplexes multiple MAC SDUs 512 from a same logical channel 510 or from different logical channels into a single TB, where the MAC header 504 includes subheaders that identify the logical channel origin and length of each MAC SDU 512.

In some cases, a CB may include one MAC SDU 512 that each include one token. A transmitting device (e.g., NE or UE) may segment a TB or MAC PDU into one or more segments or parts. The transmitting device provides each of the segments as input to a channel encoder, such as an LDPC code, turbo code, or polar code. The encoded segments may also be referred to as CBs or mini-TBs. In some examples, one CB includes data for a single logical channel 510. In some cases, each token or CB has a CRC, such that the transmitting device may attach one or more CRC bits (e.g., the CRC bits 506-b, the CRC bits 506-c, or the CRC bits 506-d) to each of the tokens or CBs. The size of the CBs for a MAC PDU or TB may differ, such that the CBs of a TB may have different sizes. The transmitting device may group several CBs to form a CB group (CBG). The TB processing and decomposition of a TB into CBs may have the one or more characteristics, including that the number of CBs per CBG is flexible, the number of bits per CB is also flexible (e.g., otherwise the transmitting device performs padding or multiplexes data from different logical channels in one CB), and the MCS or code rate per CB or CBG is flexible depending on the QoS of the data. As shown in the resource diagram 500, the TB includes data of three MAC SDUs 512 from the logical channel 510. Each MAC SDU 512 includes one token (e.g., a PDCP SDU). Accordingly, the transmitting device may select the MCS for the CBs according to the token associated QoS criterion, which reflects the semantic criterion or importance of the token.

In some cases, a transmitting device may generate a token set or token group. A token set refers to one or more tokens that represent the output of a tokenizer or algorithm for a source signal (e.g., text, image features). A token set may include less than a total numerical quantity of tokens (e.g., a plurality of tokens or a set of tokens) that the transmitting device generates. In some cases, an L2 protocol header may include token set information, which refers to control information associated with a token set. In some examples, the token set information includes a token set sequence number and information related to the sequence number of the first and last token of a token set. Additionally, or alternatively, the token set information includes information on the number of tokens within a token set and/or the number of bytes within a token set. Additionally, or alternatively, the token set information includes the importance of a token within a token set. Token set information may include information on a minimum number of tokens of a token set that a receiving device utilizes to decode a source signal (e.g., text, image, video, or slice of an image).

The receiving device may decode or generate an application unit and/or the source signal without receiving each of the tokens of the original source signal and/or application unit. For example, the receiving device may receive a subset of tokens from a token set and may still successfully reconstruct the source signal based on the received subset. The subset includes tokens with importance values that satisfy (e.g., exceed, are greater than) a threshold importance value. In some cases, the receiving device may utilize the token set information to determine whether the receiving device has received a sufficient number of tokens for decoding, and may initiate reconstruction of the source signal upon receiving the minimum number of tokens indicated in the token set information. In some other cases, the receiving device may request retransmission of missing tokens based on the importance values associated with the missing tokens, where the receiving device may prioritize tokens with higher importance values for retransmission over tokens with lower importance values. The token set information may also enable the receiving device to identify gaps in the received token sequence and to determine whether the gaps correspond to tokens that the receiving device utilizes for successful decoding or to tokens that the receiving device may omit without significantly affecting the quality of the reconstructed data.

In some examples, an NE and/or a UE define and enforce a token error rate per token or token set. A token error rate refers to an upper bound for the rate of token losses between the RAN (e.g., an NE) and the UE. In some cases, the NE and/or the UE define the token error rate per token importance. For example, tokens of a specific semantic importance have a token error rate that link adaptation (e.g., selection of an MCS) enforces over the air interface. Similarly, the NE and/or the UE define a token specific or token set specific delay budget. In some examples, an NE configures the UE for uplink transmissions with the token or token set error rates and corresponding delay budgets. For downlink, a CN node may configure the scheduler in the NE (e.g., gNB) with the token specific QoS criterion, such as token or token set error rate and delay budget. In some examples, the NE may configure the UE and/or scheduler in the NE with information related to the inter-arrival rate of tokens (e.g., time between different tokens, such as time to token).

In some cases, the NE and/or the UE introduce a new control PDU that includes metadata associated with a token or set of tokens (e.g., a token set). In some examples, the control PDU includes information regarding the sequence numbers of the highest importance tokens included in an SDU or PDU. In some examples, the control PDU includes one or more sequence numbers (e.g., starting sequence number and stopping sequence number) of tokens of a defined importance (e.g., highest importance tokens). In some other example, the control PDU includes the sequence numbers of the PDUs or SDUs that carry tokens of one token set. According to another example, the control PDU includes the number of tokens that the receiving device should receive from a set of tokens in order to enable decoding of the source signal (e.g., at the de-tokenizer). In one exemplary implementation, the transmitting device transmits the start and stop sequence numbers of the tokens that the receiving device is to receive for successful decoding at the application layer in the control PDU. In some cases, ensuring reliable delivery of a subset of tokens with importance values that exceed or satisfy a threshold value, such as the top 25% of the tokens by importance, is sufficient to achieve relatively high quality reconstruction (e.g., greater than a threshold quality) at the application layer.

An L2 protocol entity (e.g., a PDCP entity) may introduce a routing functionality that enables semantic importance aware distribution of PDCP PDUs to lower layer entities. In some examples, the routing functionality may be implemented in software within the PDCP entity (e.g., or other L2 protocol entity) that evaluates the importance value associated with each PDCP SDU or PDU and selects a destination RLC entity or logical channel based on the evaluated importance value. The routing functionality may maintain a lookup table that maps ranges of importance values to corresponding RLC entity identifiers or logical channel identifiers, where the PDCP entity queries the lookup table upon receiving each SDU from a higher layer to determine the routing destination. In some cases, the routing functionality may include a circuit or logic that compares the importance value of an incoming PDCP SDU against one or more threshold values, where the comparison result determines which of multiple associated RLC entities receives the corresponding PDCP PDU. In some cases, the routing function selectively forwards PDCP PDUs to different RLC entities when a single PDCP entity is associated with multiple RLC entities. In some other cases, the routing function routes PDCP PDUs based on an importance value associated with each PDCP PDU to different logical channels, such as for configurations where one RLC entity with multiple logical channels is associated with the PDCP entity. The transmitting device thereby transmits high importance tokens using different uplink transmission parameters than low importance tokens, enabling differentiated QoS for semantically heterogeneous data.

In some examples, the transmitting device selects uplink transmission parameters as a function of the importance or value of the token (e.g., a semantic value associated with the token), such as the MCS, a HARQ operating point or maximum numerical quantity of HARQ retransmissions, or the use of fast RLC retransmissions without RLC status reporting, among other examples. For example, the transmitting device may dynamically adapt the MCS to a token importance or value, such as token entropy or other semantic metrics. The transmitting device transmits high-entropy tokens, which may correspond to novel or information-rich content, using a more robust MCS (e.g., a lower-order modulation combined with a low code rate) to facilitate ultra-reliable delivery. The transmitting device may transmit low-entropy tokens, such as conversational fillers, using a higher-order modulation and higher code rate to maximize throughput and system capacity. Additionally, or alternatively, the transmitting device may configure a higher maximum numerical quantity of HARQ retransmissions for tokens with importance values that satisfy the threshold value, enabling additional transmission attempts before the transmitting device discards the corresponding data. Additionally, or alternatively, the transmitting device may enable fast RLC retransmissions for high importance tokens, where the transmitting device retransmits RLC PDUs without waiting for an explicit RLC status report (e.g., NACK from the receiving device).

In some examples, the transmitting device may select an RLC transmission mode in accordance with the importance of a token. An RLC transmission mode is an operational configuration of an RLC entity that determines how the RLC entity handles data transmission, acknowledgement (ACK), and/or retransmission procedures. The RLC transmission mode may include an acknowledged mode (AM), an unacknowledged mode (UM), or a transparent mode (TM). In AM, the RLC entity performs segmentation, reassembly, and retransmission of RLC PDUs based on feedback from a receiving RLC entity, providing reliable data delivery through automatic repeat request (ARQ) procedures. In UM, the RLC entity performs segmentation and reassembly without retransmission procedures, which may reduce latency. In TM, the RLC entity passes data through without segmentation or ARQ procedures. In some cases, the transmitting device may implement an UM for non-important or low importance tokens (e.g., importance values less than a threshold value), while the transmitting device may transmit higher-importance tokens using a more reliable RLC configuration.

The receiving device (e.g., at a de-tokenizer or application layer decoder) may ensure successful delivery of tokens with importance values that satisfy (e.g., exceed, are greater than) a threshold value. The receiving device may utilize the importance values associated with received tokens to prioritize decoding and reconstruction operations, where the receiving device processes high importance tokens before lower-importance tokens when computational resources are constrained. The active selection based on token importance, which includes selectively discarding or downgrading QoS for less important tokens, enables highly efficient transmission schemes that reduce the total amount of data transmitted, while preserving perceptual or semantic quality.

An NE may configure a UE with different uplink transmission modes to apply for one or more radio bearers. In a first transmission mode, the UE transmits tokens associated with a given radio bearer under uniform QoS criterion. That is, the UE treats each PDU of the radio bearer identically from a QoS perspective. In a second transmission mode, the NE configures the UE to transmit tokens of the same radio bearer according to a corresponding semantic value or importance, thereby enabling a semantic aware transmission strategy over the air interface. In the second transmission mode, the UE distributes tokens included in a PDCP PDU in a semantic importance aware manner to lower layer entities. In some examples, the transmitting device implements a routing function to selectively forward PDCP PDUs to different RLC entities when a single PDCP entity is associated with multiple RLC entities, or route PDCP or RLC PDUs to different logical channels based on an importance value associated with each PDCP or RLC PDU, where a single RLC entity with multiple logical channels is associated with the PDCP entity. In some cases, the NE configures the UE with multiple logical channels or multiple RLC entities. In some examples, the UE uses one predefined logical channel or RLC entity for cases in which the NE directs the UE to operate in the first transmission mode (e.g., transmitting all PDUs over one logical channel or RLC entity).

In some cases, a transmission mode instructs the transmitting device to transmit the tokens with importance values or levels that satisfy (e.g., exceed, are greater than) a signaled or configured threshold value. The transmitting device may discard tokens below the threshold value. The transmitting device may send a sequence number gap indication control PDU to the receiving device (e.g., a PDCP or an RLC entity at the receiving device) for discarded PDUs that have already been assigned sequence numbers, thereby explicitly informing the receiving device about PDUs or SDUs that the transmitting device intentionally did not transmit.

In some examples, a transmission mode instructs the UE to apply different PDCP discard timers to PDCP SDUs or tokens based on the semantic importance of the corresponding PDCP SDU. A PDCP discard timer refers to a timer that, upon expiration, causes the UE to discard a PDCP SDU. In some examples, the UE applies a longer PDCP discard timer value to high importance SDUs (e.g., SDUs that include tokens with an importance value that satisfies, exceeds, is greater than a threshold value), whereas the UE applies a shorter PDCP discard timer value to lower importance SDUs (e.g., SDUs that include tokens with an importance value that satisfies, is less than a threshold value). In some cases, the NE configures a mapping between the PDCP discard timer value and the importance value to the UE. For example, the NE transmits RRC signaling to the UE that includes a configuration table associating importance value ranges with corresponding PDCP discard timer values. The NE may configure the UE such that tokens with importance values in a first range are associated with a first PDCP discard timer, tokens with importance values in a second range are associated with a second PDCP discard, and so on. The UE may retain high importance tokens in the transmission buffer for a longer duration before discarding them, which provides additional opportunities for the UE to transmit the high importance tokens when uplink resources become available. The UE may discard low importance tokens more quickly if the UE has not transmitted the tokens within a shorter timer duration, which may free buffer space and reduce congestion for higher importance data.

The NE may signal the selected transmission mode in a DCI message or via a MAC-CE. Additionally, or alternatively, the NE indicates the transmission mode for a radio bearer through RRC signaling. In some cases, the transmission mode indication message includes one or more radio bearer and/or logical channel identifiers. The logical channel identifiers may include, but are not limited to, a logical channel identity (LCID) value that uniquely identifies a logical channel within a radio bearer configuration or identifiers associated with signaling radio bearers (SRBs), such as SRB1 or SRB2, or data radio bearers (DRBs) configured for the UE. In some examples, the logical channel identifiers may be represented as integer values within a defined range, where each value corresponds to a logical channel that the NE configures. The transmission mode indication message may include one or more of the logical channel identifiers or radio bearer identifiers to indicate which logical channels respectively radio bearers are subject to the indicated transmission mode configuration.

In some cases, an RLC status report conveys information defining importance or semantic value levels that are to be subject to retransmission when a NACK is received. If an RLC PDU with a sequence number for which the receiving device requested a retransmission has an importance or semantic value above the signaled threshold, then the transmitting device performs a retransmission of the corresponding RLC PDU or SDU, thereby reducing or avoiding retransmissions for lower importance data and improving resource efficiency. A receiving device may proactively request retransmission of one or more defined tokens (e.g., the first x tokens of a sequence or tokens associated with specific sequence numbers), enabling fine-grained, importance aware control of retransmission behavior.

Each incoming packet of a radio bearer or QoS flow (e.g., a PDCP SDU) may have a tag (e.g., including associated metadata), and based on the tag the UE routes the packet to a defined logical channel. A tag may refer to a label or identifier associated with a data packet that indicates one or more attributes of the packet, such as an importance value, a token set identifier, a sequence number, or other metadata that the UE uses to determine routing decisions. In some cases, the tag may be embedded within a header field of the packet, such as a PDCP header or an IP header, and may be populated by an application layer or a higher-layer protocol before delivery to the access stratum. The NE may configure the UE with a set of expected tags or a range of tag values for a radio bearer or QoS flow via RRC signaling, where the configuration indicates how different tag values map to corresponding logical channels or RLC entities. In some examples, the tag may include a numerical value within a defined range, and the NE may provide mapping rules that associate ranges of tag values with specific logical channels having different transmission parameters or QoS configurations. The UE may extract the tag from an incoming packet and use the configured mapping rules to route the packet to a logical channel for transmission.

The routing may occur within the PDCP layer or RLC layer. For example, the UE may implement the routing functionality at the PDCP layer, where a PDCP entity determines the importance value or tag associated with each PDCP SDU and forwards the corresponding PDCP PDU to one of multiple associated RLC entities based on the configured mapping. In some other cases, the UE may implement the routing functionality at the RLC layer, where an RLC entity receives PDCP PDUs and routes them to different logical channels based on the importance values indicated in the PDCP header or associated metadata. The routing at the PDCP layer may provide earlier differentiation of token handling, while routing at the RLC layer may provide flexibility in managing logical channel assignments after PDCP processing is complete.

In some cases, a single radio bearer may be associated with multiple logical channels to enable differentiated handling of tokens based on their semantic importance values. For example, the radio bearer may map to multiple logical channels and/or RLC entities. The NE establishes different logical channels for the radio bearer, and provides the corresponding mapping rules to the UE. In some examples, the NE configures a first logical channel with a low MCS index and a high maximum number of HARQ retransmissions for tokens with importance values that satisfy a threshold importance value, and configures a second logical channel with a higher MCS index and fewer HARQ retransmissions for tokens with importance values below the threshold. In some cases, the NE may configure a third logical channel operating in RLC UM for tokens with the lowest importance values, where the absence of RLC level status reports reduces signaling overhead at the cost of reliability. The UE receives the logical channel configurations and the mapping rules via RRC signaling, and subsequently routes incoming PDCP SDUs to the logical channel based on the importance value indicated in the associated metadata.

In some cases, the routing may change dynamically based on a remaining time budget associated with a token or token set. For example, the UE may initially route a token to a logical channel configured with higher throughput parameters, and may subsequently reroute the token to a logical channel configured with more robust transmission parameters when the remaining time budget falls below a threshold value. The dynamic rerouting enables the UE to balance throughput efficiency with reliability based on the urgency of the transmission.

In some examples, the logical channels associated with a radio bearer may be characterized by different parameters, including a priority level, a HARQ configuration specifying a maximum number of HARQ retransmissions, an ARQ configuration, an MCS or MCS range, support for fast RLC retransmission, a scheduling request configuration, or a buffer status report configuration, among other examples. The NE may configure the parameters independently for each logical channel, enabling fine-grained control over the transmission characteristics applied to tokens of different importance levels.

In some cases, an RLC transmitting entity maintains (e.g., stores, tracks, manages, updates, or monitors) a maximum numerical quantity (e.g., number, amount) of RLC transmissions and/or retransmissions on a per-packet basis. An RLC retransmission refers to a procedure in which an RLC transmitting entity resends an RLC PDU or SDU that was previously transmitted but not successfully received by the corresponding RLC receiving entity, as indicated by a NACK or the absence of a positive ACK within a defined time period. The RLC transmitting entity assigns a maximum numerical quantity of retransmissions depending on the relevance or the QoS attributes of an RLC SDU or PDU. For example, the RLC transmitting entity may assign a higher maximum numerical quantity of retransmissions to RLC SDUs or PDUs that carry tokens with importance values that satisfy (e.g., exceed, are greater than) a threshold importance value. Additionally, or alternatively, the RLC transmitting entity may assign a lower maximum numerical quantity of retransmissions to RLC SDUs or PDUs that carry tokens with importance values below the threshold importance value. In some cases, the RLC transmitting entity may determine the maximum numerical quantity of transmissions and/or retransmissions based on a mapping table that associates ranges of importance values with corresponding retransmission criterion. In some other cases, the RLC transmitting entity may receive the maximum numerical quantity of retransmissions as part of metadata associated with the RLC SDU or PDU from a higher layer entity. Within a single radio bearer or logical channel, packets may have different importance levels or QoS attributes.

In some examples, the RLC transmitting entity determines the maximum transmission and/or retransmission value based on the importance level of the corresponding RLC SDU or PDU. In another implementation, the RLC transmitting entity selects the maximum retransmission value based on certain metadata parameters associated with the RLC SDU. For example, the network may configure a mapping between SDU/PDU importance (or other metadata fields) and the corresponding allowed maximum number of retransmissions. The NE may provide the mapping rules to the RLC transmitting entity, such as via RRC signaling or via a MAC-CE. In some cases, the NE may transmit the mapping rules as part of a radio bearer setup or reconfiguration procedure, where the RRC message includes a list of importance value ranges and corresponding maximum retransmission values. In some other cases, the NE may provide the mapping rules through a dedicated RLC configuration IE that specifies a table associating importance levels with retransmission limits. The NE may also indicate the mapping rules via broadcast signaling, such as a system information block (SIB), for configurations that apply to multiple UEs within a cell. In some examples, the NE may update the mapping rules dynamically based on network conditions or traffic load by transmitting a MAC-CE that modifies one or more entries in the previously configured mapping table. The transmitting device may perform per-packet control of RLC retransmissions, providing for differentiated retransmission handling based on packet characteristics.

In some cases, RLF detection is defined based on exceeding a fixed maximum number of RLC transmissions and/or retransmissions. The NE and/or UE update the RLF definition to support per-packet maximum retransmission configurations. For example, the NE may configure an RLF trigger threshold (e.g., the maximum numerical quantity of RLC transmissions and/or retransmissions triggering an RLF for an RLC entity) that is separate from the per-packet maximum transmissions and/or retransmission values. The NE may configure a new IE for an RLC entity (e.g., within the IE RLC-config) that indicates the numerical quantity of RLC transmissions and/or retransmissions triggering an RLF. In some examples, one or more maximum retransmission threshold (maxRetxThreshold) values configured for the RLC SDUs or PDUs (e.g., based on the QoS criterion or importance) are defined separately from the maximum retransmission threshold used to trigger RLF.

The RLF trigger threshold may represent a cumulative count of failed transmissions across multiple packets or a count of consecutive transmission failures for packets associated with an importance level. In some cases, the NE configures the UE with an RLF maximum transmission number threshold that applies to an RLC entity, where the UE triggers an RLF when an RLC transmission counter reaches or exceeds the configured threshold. The RLC transmission counter may track the total number of transmission attempts for a packet, including the initial transmission and any subsequent retransmissions. In some examples, the UE maintains separate counters for different importance levels, and the NE may configure different RLF thresholds for each importance level. The UE may trigger an RLF based on the counter for high importance packets reaching the corresponding threshold, while allowing additional transmission attempts for lower-importance packets without triggering an RLF. In some other cases, the UE may aggregate transmission failures across importance levels and trigger an RLF when the aggregate count satisfies a configured threshold. The separation of per-packet maximum retransmission values from the RLF trigger threshold enables the UE to discard individual low importance packets after a limited number of retransmission attempts while continuing to operate on the radio link, and to trigger an RLF when transmission failures indicate a more persistent link degradation that affects high importance traffic.

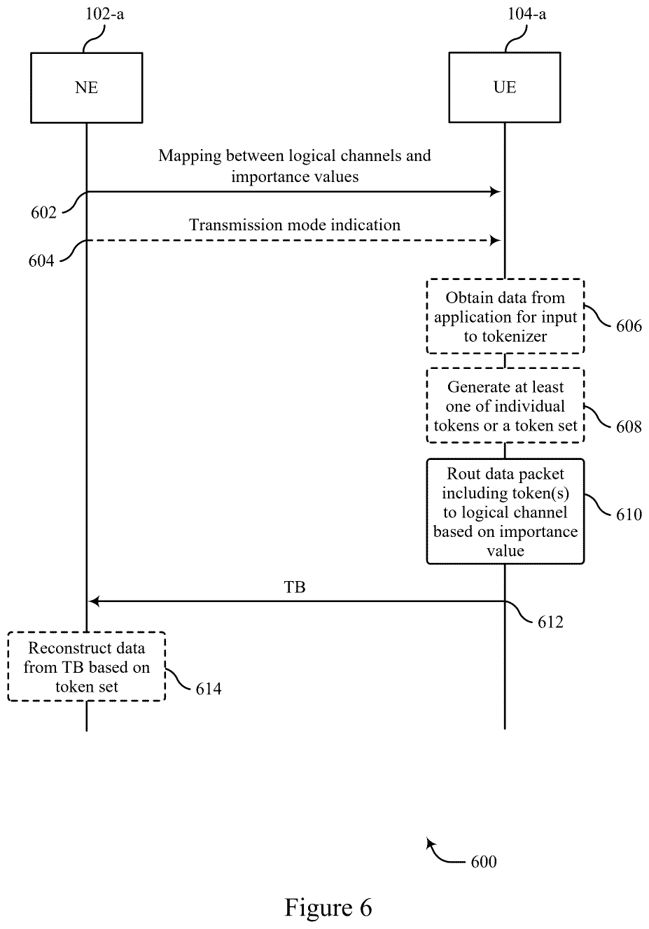

FIG. 6 illustrates an example of a signaling diagram 600 in accordance with aspects of the present disclosure. In some examples, the signaling diagram 600 implements or is implemented by aspects of the wireless communications system 100, the transmission diagram 200, the transmission diagram 300, the transmission diagram 400, and the resource diagram 500. The signaling diagram 600 may implement or be implemented by an NE 102-a and a UE 104-a, which may be examples of the corresponding devices as described with reference to FIG. 1. For example, the NE 102-a may provide the UE 104-a with a configuration for routing data packets based on token importance values. Alternative examples of the following may be implemented, where some processes are performed in a different order than described or are not performed. In some cases, processes may include additional features not mentioned below, or further processes may be added.

In some examples, the NE 102-a may be an example of a base station (e.g., a gNB) or another network element configured to support wireless communication with the UE 104-a. The UE 104-a may be an example of a mobile device, a wireless device, or another UE configured to support token-based data transmission. The UE 104-a may be an example of a transmitting device, such as a transmitting device 302 or a transmitting device 402, as described with reference to FIG. 3. The NE 102-a may be an example of a receiving device 304 or a receiving device 404, as described with reference to FIG. 4. In some cases, the NE 102-a may implement or may be capable of implementing the token-based data transmission (e.g., to one or more UEs).

At 602, the NE 102-a transmits a mapping between logical channels and importance values to the UE 104-a. The mapping indicates associations between a set of logical channels and a set of importance values assigned to a set of tokens. The set of tokens is generated by an application, such as an artificial intelligence application or a data processing application. In some examples, the NE 102-a transmits the mapping via RRC signaling. The mapping enables the UE 104-a to route data packets including tokens to logical channels according to the importance values assigned to the tokens. In some cases, the importance values may range from 0 to 255, providing up to 256 different importance levels for tokens. The importance values may be determined by the application layer, which has knowledge of the semantic relevance of each token for reconstruction of the source data. In some examples, the CN, such as a policy and charging control (PCC) function or non-access stratum (NAS) signaling, may configure the UE 104-a with rules for determining token importance. The rules may be based on filter criteria such as the size of a PDU, dependency information indicating whether a token depends on another token, or other packet attributes. Tokens that have dependencies may be assigned higher importance values because loss of such tokens would also render dependent tokens unusable.

In some cases, the signaling indicates a range of tags including data packet metadata. The range of tags may be associated with a radio bearer that is mapped to the set of logical channels. For example, the NE 102-a may configure the UE 104-a with a tag range from a first tag value to a second tag value, where each tag value within the range corresponds to a different importance level or importance value range. The UE 104-a may extract a tag from an incoming PDCP SDU and compare the tag against the configured range to determine which logical channel to use for transmission. In some cases, the tag may be embedded within a header field of the PDCP SDU, such as a dedicated importance indicator field or a metadata field populated by the application layer. In some other cases, the tag may be derived from other packet attributes, such as a QoS flow identifier or a traffic class indicator, that the NE 102-a maps to importance values through the configured mapping rules.

In some examples, the NE 102-a may also transmit additional signaling that indicates an additional mapping between the set of importance values and a set of maximum retransmission values for a RLC entity. The additional signaling may indicate an RLF maximum transmission number threshold configured for the RLC entity. For example, the NE 102-a may transmit RRC signaling that includes a configuration table associating importance value ranges with corresponding maximum retransmission values. In some cases, tokens with importance values in a first range are associated with a first maximum retransmission value, tokens with importance values in a second range are associated with a second maximum retransmission value, and so on. High importance tokens may be configured with a higher maximum number of RLC retransmissions to ensure reliable delivery, whereas low importance tokens may be configured with a lower maximum number of retransmissions or even a single transmission without retransmission. The additional signaling may also include an RLF maximum transmission number threshold that is separate from the per-packet maximum retransmission values, where the UE 104-a triggers an RLF when an RLC transmission counter reaches or exceeds the configured RLF threshold. In some cases, the NE 102-a may update the additional mapping dynamically based on network conditions or traffic load by transmitting a MAC-CE that modifies one or more entries in the previously configured mapping table. In contrast to wireless communications systems where the maximum number of RLC retransmissions is maintained uniformly across packets in one logical channel, the described techniques enable maintaining the maximum number of retransmissions on a per-packet level based on the importance value of the token within the packet.

In some cases, the NE 102-a may transmit additional signaling that enables concatenation of two or more tokens of the set of tokens in a data packet. The additional signaling may include at least one parameter that indicates the concatenation is enabled, a token size configured for the concatenation, or a maximum numerical quantity of tokens permitted for the concatenation. The concatenation parameters enable the UE 104-a to multiplex multiple tokens having the same importance value into a single data packet, reducing overhead and improving transmission efficiency. Tokens may have relatively small sizes, such as 24 bits for text tokens, 20 bits for image tokens, or up to 500 bits for video tokens. Transmitting small tokens separately may result in significant overhead because each token utilizes a separate header and security algorithms are run separately for each token, which is processing intensive. Therefore, concatenating tokens of the same importance value into a single PDU reduces both header overhead and processing complexity.

In some cases, at 604, the NE 102-a transmits a transmission mode indication to the UE 104-a. The transmission mode indication indicates to apply, for a radio bearer or at least one logical channel, at least one transmission mode of a set of transmission modes for transmission of a set of data packets. In some examples, the transmission mode indication is transmitted via a MAC-CE. In some other examples, the transmission mode indication is transmitted via DCI or RRC signaling. The transmission mode indication message may include one or more radio bearer and/or logical channel identifiers. The transmission mode indication enables the network to dynamically control how the UE 104-a handles token-based transmissions, allowing the network to switch between uniform QoS treatment and semantic aware differentiated treatment based on network conditions or application criterion.

In some examples, the set of transmission modes includes a first transmission mode that indicates to route the set of data packets to a single logical channel of the set of logical channels and a second transmission mode that indicates to route the set of data packets to the set of logical channels according to the set of importance values. In the first transmission mode, the UE 104-a transmits the tokens for a given radio bearer under uniform QoS criterion, treating each PDU of the radio bearer identically from a QoS perspective. The first transmission mode may include packets of one logical channel or radio bearer being treated the same over the air interface. In the second transmission mode, the UE 104-a transmits tokens of the same radio bearer according to semantic value or importance, enabling a semantic aware transmission. The second transmission mode activates the routing functionality that distributes PDCP PDUs to different logical channels based on the importance values, where each logical channel may be configured with different transmission parameters, such as different priorities, different MCS values, or different HARQ configurations, among other examples.

In some cases, the set of transmission modes includes a transmission mode that indicates to transmit tokens of the set of tokens having respective importance values that satisfy a threshold importance value and to discard remaining tokens of the set of tokens. The UE 104-a may send a sequence number gap indication control PDU to the receiving side for discarded PDUs that have already been assigned sequence numbers, thereby explicitly informing the receiver about PDUs or SDUs that were intentionally not transmitted.

In some other cases, the set of transmission modes includes a transmission mode that indicates to apply a set of discard timers to the set of tokens according to respective importance values assigned to the set of tokens. For example, the UE 104-a may apply a longer PDCP discard timer value to high importance SDUs, whereas the UE 104-a may apply a shorter PDCP discard timer value to lower importance SDUs.

In some examples, at 606, the UE 104-a obtains data from an application for input to a tokenizer. The data represents source information, such as text, images, video, or audio, that the UE 104-a prepares for transmission over the air interface. The application may be an artificial intelligence application, a data processing application, or another application that generates data for token-based transmission. The application layer provides the data along with associated importance information to the access stratum through UE internal operations.

In some cases, at 608, the UE 104-a generates at least one of individual tokens or a token set from the data. The token set includes one or more tokens that represent the output of the tokenizer for the source signal. For example, a token set represents a set of tokens that together represent a source signal, such as a text, a slice of an image, or a tile of a video frame. Each token in the token set has an assigned importance value that indicates a semantic relevance of the token for reconstruction of the data. In some examples, the importance value indicates the degree to which a token contributes information or context that affects the quality of data reconstruction at the application layer. Tokens having higher importance values have greater semantic relevance and may be more valuable for preserving the intended meaning or utility of the original source data when processed by a de-tokenizer or application layer decoder. High importance tokens may also be referred to as high entropy tokens because they include novel or information that cannot be easily predicted, whereas low importance tokens may be referred to as low entropy tokens because they include less novel information that can potentially be predicted by artificial intelligence models at the receiver (e.g., even if the tokens are not received).

In some cases, at least one of the token set or respective tokens of the token set is associated with one or more of a delay budget or a token error rate. The token error rate may be determined from respective importance values of a subset of tokens of the token set. For example, tokens of a specific semantic importance may have a token error rate that link adaptation enforces over the air interface.

At 610, the UE 104-a routes a data packet including tokens to a logical channel according to the importance value assigned to the tokens. The UE 104-a routes the data packet using the mapping received from the NE 102-a at 602. In some examples, the data packet is routed within at least one of a PDCP layer or an RLC layer. A routing functionality in an L2 protocol entity enables semantic importance aware distribution of PDCP PDUs to lower layer entities. The routing function may selectively forward PDCP PDUs to different RLC entities when a single PDCP entity is associated with multiple RLC entities, or may route PDCP PDUs to different logical channels according to an importance value assigned to each PDCP PDU. The routing functionality may reside in the PDCP layer or in a different protocol layer.

In some cases, the UE 104-a selects uplink transmission parameters as a function of the importance value of the token. The uplink transmission parameters may include an MCS, a HARQ operating point, a maximum numerical quantity of HARQ retransmissions, or an RLC transmission mode. For example, the UE 104-a may transmit high importance tokens using a more robust MCS, such as QPSK with low-rate LDPC codes, to facilitate ultra-reliable delivery, while transmitting low importance tokens using a higher order modulation, such as 1024-QAM with high-rate polar codes, to maximize throughput. The UE 104-a may also enable fast RLC retransmissions for high importance tokens, where if HARQ fails because the initial MCS was not selected properly, then the UE 104-a triggers an RLC retransmission rather than waiting for the receiving device to detect gaps and send a status report. The fast retransmission approach reduces latency for recovering high importance tokens compared to when RLC retransmissions are triggered after the receiving device detects missing sequence numbers and sends a status report.

In some examples, the data packet includes a header that indicates information describing the token set. The information may include one or more of a first sequence number identifying the token set, a second sequence number identifying an initial token in the token set, a third sequence number identifying a final token in the token set, a numerical quantity of tokens within the token set, a numerical quantity of bytes within the token set, respective importance values of one or more tokens of the token set, or a minimum numerical quantity of successfully decoded tokens for the token set. The header information enables the receiving device to process and reconstruct the transmitted data using the received tokens and their assigned importance values.

In some cases, the UE 104-a may multiplex two or more tokens in the data packet using the additional signaling received from the NE 102-a. The two or more tokens share the same importance value. The UE 104-a may concatenate tokens that share the same importance value into a single PDU, reducing overhead and improving transmission efficiency. In some examples, the NE 102-a may configure a reference uplink grant that provides for the UE 104-a to predict the grant size for a logical channel, enabling the UE 104-a to determine how many tokens can be concatenated without subsequent segmentation due to insufficient uplink grant size.

In some examples, the UE 104-a maintains, for the data packet, a maximum number (e.g., numerical quantity, amount) of RLC retransmissions determined by the importance value and the additional mapping received from the NE 102-a. The UE 104-a may trigger an RLF when an RLC transmission counter reaches or exceeds (e.g., satisfies) the RLF maximum transmission number threshold configured by the NE 102-a.

At 612, the UE 104-a transmits a TB to the NE 102-a. The TB includes the data packet with the routed tokens. In some examples, the UE 104-a generates the TB including the data packet, segments the TB into a set of CBs, and selects, for the set of CBs, one or more respective transmission parameters determined by respective importance values assigned to tokens within the set of CBs. The one or more respective transmission parameters may include an MCS, a HARQ operating point, a maximum numerical quantity of HARQ retransmissions, or an RLC transmission mode. The UE 104-a transmits the TB to the NE 102-a using the one or more respective transmission parameters. In some cases, the segmentation into CBs is performed in a token aware manner, such that different tokens are separated, and each CB includes a single token or tokens that share the same importance value. Each CB is encoded with a channel encoder, such as a polar code, and is associated with a CRC. The token aware CB segmentation enables the receiving device to determine whether one or more CBs have been correctly received even if the complete TB was not correctly decoded. The receiving device may deliver correctly received high importance tokens to higher layers and request retransmission for CBs that were not correctly decoded based on the CRC.

In some cases, the UE 104-a may transmit an RLC status report that indicates for one or more tokens of the set of tokens to be retransmitted in response to a NACK. The one or more tokens have one or more importance values of the set of importance values that satisfy a threshold importance value. The RLC status report may indicate that retransmission is requested for high importance tokens, while low importance tokens that were not correctly received may not be requested for retransmission.

In some examples, the UE 104-a may transmit a control data packet including metadata describing the token set. The metadata may include one or more of respective first sequence numbers identifying one or more first tokens of the token set having respective importance values that satisfy a threshold importance value, a second sequence number identifying an initial token in the token set, a third sequence number identifying a final token in the token set, a minimum numerical quantity of successfully decoded tokens for the token set, or one or more fourth sequence numbers identifying one or more second tokens of the token set that enable the token set to be successfully decoded.

At 614, the NE 102-a reconstructs the data from the received TB using the token set. The NE 102-a receives the token set including the at least one token, where the token set represents data. The NE 102-a reconstructs the data using the token set and one or more importance values assigned to respective tokens of the token set. The one or more importance values indicate a semantic relevance of the respective tokens for reconstruction of the data. In some cases, the NE 102-a may utilize the importance values to prioritize processing of high value tokens, enabling reconstruction of the data even when some lower-importance tokens are missing or received with errors. The NE 102-a may perform a reordering process based on the importance values. For example, if the NE 102-a knows that a missing PDU includes a low importance token, then the NE 102-a may deliver received high importance PDUs to higher layers without waiting for the low importance token.

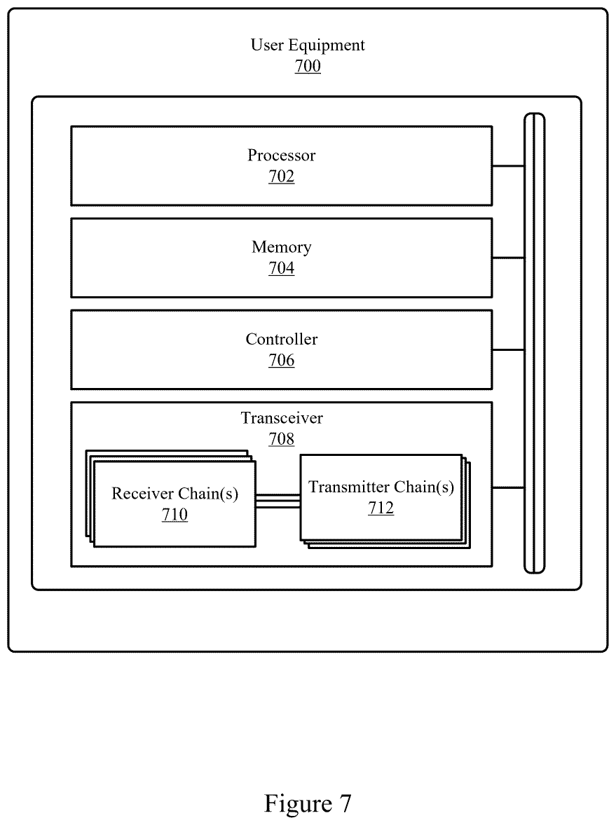

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a DSP, an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a central processing unit (CPU), an ASIC, a field-programmable gate-array (FPGA), or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to or operable to support a means for receiving signaling that indicates a mapping between a set of logical channels and a set of importance values associated with a set of tokens, where the set of tokens is associated with an application, and routing a data packet including at least one token of the set of tokens to a logical channel of the set of logical channels based on an importance value associated with the at least one token and the mapping. By receiving the mapping and routing data packets based on token importance values, the UE 700 enables differentiated QoS handling, where semantically relevant tokens are transmitted via logical channels configured with more reliable transmission parameters.

Additionally, the UE 700 may be configured to or operable to support any one or combination of obtaining, from the application, data for input to a tokenizer, and generating a token set based on the data, where the token set includes the at least one token, and where the importance value indicates a semantic relevance of the at least one token for reconstruction of the data. By obtaining data from the application and generating a token set with associated importance values indicating semantic relevance, the UE 700 enables semantic aware transmission that prioritizes tokens for data reconstruction, thereby improving overall communication efficiency for applications. Additionally, or alternatively, the UE 700 may be configured to or operable to support the data packet includes a header that indicates information associated with the token set, and where the information includes one or more of a first sequence number associated with the token set, a second sequence number associated with an initial token in the token set, a third sequence number associated with a final token in the token set, a numerical quantity of tokens within the token set, a numerical quantity of bytes associated with the token set, respective importance values of one or more tokens of the token set, or a minimum numerical quantity of successfully decoded tokens associated with the token set. By including header information associated with the token set, the UE 700 enables the receiving device to efficiently process and reconstruct the transmitted data by providing metadata that facilitates token identification, ordering, and importance-based prioritization during decoding.

Additionally, or alternatively, the UE 700 may be configured to or operable to support at least one of the token set or respective tokens of the token set is associated with one or more of a delay budget or a token error rate, and where the token error rate is based on respective importance values of a subset of tokens of the token set. By associating delay budgets or token error rates with tokens based on importance values, the UE 700 enables improved transmission scheduling that ensures high importance tokens meet latency criterion, while allowing more flexible handling of low importance tokens to maximize overall system capacity. Additionally, or alternatively, the UE 700 may be configured to or operable to support transmitting a control data packet including metadata associated with the token set, where the metadata includes one or more of respective first sequence numbers corresponding to one or more first tokens of the token set associated with respective importance values that satisfy a threshold importance value, a second sequence number associated with an initial token in the token set, a third sequence number associated with a final token in the token set, a minimum numerical quantity of successfully decoded tokens associated with the token set, or one or more fourth sequence numbers associated with one or more second tokens of the token set corresponding to the token set being successfully decoded. By transmitting control data packets with token set metadata, the UE 700 enables the receiving device to improve processing operations, such as reordering and retransmission requests, based on token importance information.

Additionally, or alternatively, the UE 700 may be configured to or operable to support receiving additional signaling that indicates to apply, for a radio bearer or at least one logical channel, at least one transmission mode of a set of transmission modes for transmission of a set of data packets including the data packet, where the additional signaling includes a MAC-CE. By receiving transmission mode indications via MAC-CE signaling, the UE 700 enables dynamic adaptation of transmission behavior based on network conditions, allowing flexible switching between uniform and semantic aware transmission schemes to improve resource utilization. Additionally, or alternatively, the UE 700 may be configured to or operable to support the set of transmission modes includes a first transmission mode that indicates to route the set of data packets to a single logical channel of the set of logical channels and a second transmission mode that indicates to route the set of data packets to the set of logical channels based on the set of importance values. By supporting multiple transmission modes including both uniform routing and importance-based routing, the UE 700 provides flexibility to handle different traffic types and network conditions, while enabling semantic aware transmission.

Additionally, or alternatively, the UE 700 may be configured to or operable to support the set of transmission modes includes a transmission mode that indicates to transmit tokens of the set of tokens associated with respective importance values that satisfy a threshold importance value and to discard remaining tokens of the set of tokens. By supporting a transmission mode that selectively transmits high importance tokens and discards low importance tokens, the UE 700 enables efficient bandwidth utilization during congested conditions. Additionally, or alternatively, the UE 700 may be configured to or operable to support the set of transmission modes includes a transmission mode that indicates to apply a set of discard timers to the set of tokens based on respective importance values associated with the set of tokens. By applying importance-based discard timers to tokens, the UE 700 enables prioritized retention of high importance tokens in transmission buffers, ensuring that semantically relevant tokens have greater opportunity for successful transmission, while efficiently managing buffer resources.

Additionally, or alternatively, the UE 700 may be configured to or operable to support receiving additional signaling that enables concatenation of two or more tokens of the set of tokens in the data packet, where the additional signaling includes at least one parameter that indicates the concatenation is enabled, a token size associated with the concatenation, or a maximum numerical quantity of tokens associated with the concatenation, and multiplexing, based on the additional signaling, the two or more tokens in the data packet, where the two or more tokens include the at least one token and are associated with the importance value. By enabling concatenation of tokens with the same importance value, the UE 700 reduces protocol overhead and processing complexity associated with transmitting small sized tokens individually. Additionally, or alternatively, the UE 700 may be configured to or operable to support the signaling indicates a range of tags including data packet metadata, where the range of tags is associated with a radio bearer that is mapped to the set of logical channels, and where the data packet is routed within at least one of a PDCP layer or an RLC layer. By utilizing tags for data packet metadata and enabling routing within PDCP or RLC layers, the UE 700 provides flexible implementation options for semantic aware routing that can be integrated with existing protocol stack architectures. Additionally, or alternatively, the UE 700 may be configured to or operable to support transmitting an RLC status report that indicates for one or more tokens of the set of tokens to be retransmitted based on a NACK, where the one or more tokens are associated with one or more importance values of the set of importance values that satisfy a threshold importance value. By transmitting RLC status reports that selectively request retransmission of high importance tokens, the UE 700 enables efficient use of retransmission resources by prioritizing recovery of semantically high importance tokens, while reducing or preventing retransmissions of low importance tokens.

Additionally, or alternatively, the UE 700 may be configured to or operable to support generating a TB including the data packet, segmenting the TB into a set of CBs, where a CB of the set of CBs includes the at least one token, selecting, for the set of CBs, one or more respective transmission parameters based on respective importance values associated with tokens within the set of CBs, where the one or more respective transmission parameters include an MCS, a HARQ operating point, a maximum numerical quantity of HARQ retransmissions, or an RLC transmission mode, and transmitting the TB to an NE based on the one or more respective transmission parameters. By performing token aware segmentation into CBs and selecting transmission parameters based on token importance, the UE 700 enables differentiated physical layer treatment where high importance tokens receive more robust transmission configurations, improving reliability for high importance semantic content. Additionally, or alternatively, the UE 700 may be configured to or operable to support the signaling includes RRC signaling, and where the data packet includes a header that indicates the importance value. By receiving configuration via RRC signaling and including importance values in data packet headers, the UE 700 enables persistent configuration of semantic aware transmission parameters, while providing per-packet importance indication for flexible processing at the receiving device.

Additionally, or alternatively, the UE 700 may be configured to or operable to support receiving additional signaling that indicates an additional mapping between the set of importance values and a set of maximum retransmission values for an RLC entity, and maintaining, for the data packet, a maximum number of RLC retransmissions based on the importance value and the additional mapping. By maintaining importance-based maximum RLC retransmission values, the UE 700 enables differentiated reliability treatment at the RLC layer, where high importance tokens receive more retransmission opportunities. Additionally, or alternatively, the UE 700 may be configured to or operable to support the additional signaling indicates an RLF maximum transmission number threshold associated with the RLC entity, and triggering an RLF based on an RLC transmission counter satisfying the RLF maximum transmission number threshold. By supporting importance aware RLF triggering based on RLC transmission counters, the UE 700 enables RLF detection that accounts for the differentiated retransmission treatment of tokens with different importance values, preventing premature or delayed RLF declarations in semantic aware transmission scenarios.

Additionally, or alternatively, the UE 700 may support at least one memory (e.g., the memory 704) and at least one processor (e.g., the processor 702) coupled with the at least one memory and configured to cause the UE to receive signaling that indicates a mapping between a set of logical channels and a set of importance values associated with a set of tokens, where the set of tokens is associated with an application, and route a data packet including at least one token of the set of tokens to a logical channel of the set of logical channels based on an importance value associated with the at least one token and the mapping.

Additionally, to route the data packet, the UE 700 may be configured to support any one or combination of to obtain, from the application, data for input to a tokenizer, and generate a token set based on the data, where the token set includes the at least one token, and where the importance value indicates a semantic relevance of the at least one token for reconstruction of the data. Additionally, or alternatively, the UE 700 may be configured to or operable to support the data packet includes a header that indicates information associated with the token set, and where the information includes one or more of a first sequence number associated with the token set, a second sequence number associated with an initial token in the token set, a third sequence number associated with a final token in the token set, a numerical quantity of tokens within the token set, a numerical quantity of bytes associated with the token set, respective importance values of one or more tokens of the token set, or a minimum numerical quantity of successfully decoded tokens associated with the token set. Additionally, or alternatively, the UE 700 may be configured to or operable to support at least one of the token set or respective tokens of the token set is associated with one or more of a delay budget or a token error rate, and where the token error rate is based on respective importance values of a subset of tokens of the token set. Additionally, or alternatively, the UE 700 may be configured to or operable to support to transmit a control data packet including metadata associated with the token set, where the metadata includes one or more of respective first sequence numbers corresponding to one or more first tokens of the token set associated with respective importance values that satisfy a threshold importance value, a second sequence number associated with an initial token in the token set, a third sequence number associated with a final token in the token set, a minimum numerical quantity of successfully decoded tokens associated with the token set, or one or more fourth sequence numbers associated with one or more second tokens of the token set corresponding to the token set being successfully decoded.

Additionally, or alternatively, the UE 700 may be configured to or operable to support to receive additional signaling that indicates to apply, for a radio bearer or at least one logical channel, at least one transmission mode of a set of transmission modes for transmission of a set of data packets including the data packet, where the additional signaling includes a MAC-CE. Additionally, or alternatively, the UE 700 may be configured to or operable to support the set of transmission modes includes a first transmission mode that indicates to route the set of data packets to a single logical channel of the set of logical channels and a second transmission mode that indicates to route the set of data packets to the set of logical channels based on the set of importance values. Additionally, or alternatively, the UE 700 may be configured to or operable to support the set of transmission modes includes a transmission mode that indicates to transmit tokens of the set of tokens associated with respective importance values that satisfy a threshold importance value and to discard remaining tokens of the set of tokens. Additionally, or alternatively, the UE 700 may be configured to or operable to support the set of transmission modes includes a transmission mode that indicates to apply a set of discard timers to the set of tokens based on respective importance values associated with the set of tokens.

Additionally, or alternatively, the UE 700 may be configured to or operable to support to receive additional signaling that enables concatenation of two or more tokens of the set of tokens in the data packet, where the additional signaling includes at least one parameter that indicates the concatenation is enabled, a token size associated with the concatenation, or a maximum numerical quantity of tokens associated with the concatenation, and multiplex, based on the additional signaling, the two or more tokens in the data packet, where the two or more tokens include the at least one token and are associated with the importance value. Additionally, or alternatively, the UE 700 may be configured to or operable to support the signaling indicates a range of tags including data packet metadata, where the range of tags is associated with a radio bearer that is mapped to the set of logical channels, and where the data packet is routed within at least one of a PDCP layer or an RLC layer. Additionally, or alternatively, the UE 700 may be configured to or operable to support to transmit an RLC status report that indicates for one or more tokens of the set of tokens to be retransmitted based on a NACK, where the one or more tokens are associated with one or more importance values of the set of importance values that satisfy a threshold importance value.

Additionally, or alternatively, the UE 700 may be configured to or operable to support to generate a TB including the data packet, segment the TB into a set of CBs, where a CB of the set of CBs includes the at least one token, select, for the set of CBs, one or more respective transmission parameters based on respective importance values associated with tokens within the set of CBs, where the one or more respective transmission parameters include an MCS, a HARQ operating point, a maximum numerical quantity of HARQ retransmissions, or an RLC transmission mode, and transmit the TB to an NE based on the one or more respective transmission parameters. Additionally, or alternatively, the UE 700 may be configured to or operable to support the signaling includes RRC signaling, and where the data packet includes a header that indicates the importance value. Additionally, or alternatively, the UE 700 may be configured to or operable to support to receive additional signaling that indicates an additional mapping between the set of importance values and a set of maximum retransmission values for an RLC entity, and maintain, for the data packet, a maximum number of RLC retransmissions based on the importance value and the additional mapping. Additionally, or alternatively, the UE 700 may be configured to or operable to support the additional signaling indicates an RLF maximum transmission number threshold associated with the RLC entity, and to trigger an RLF based on an RLC transmission counter satisfying the RLF maximum transmission number threshold.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation, frequency modulation (FM), or digital modulation schemes like phase-shift keying (PSK) or QAM. The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

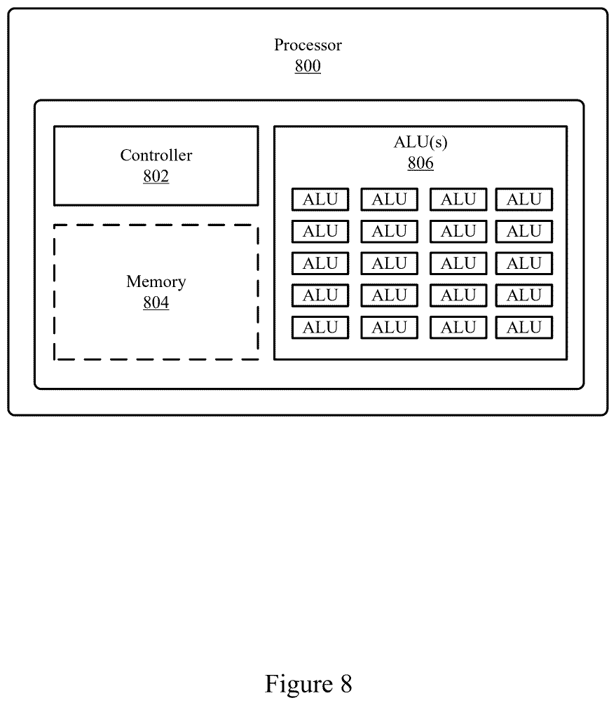

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to or operable to support at least one controller (e.g., the controller 802) coupled with at least one memory (e.g., the memory 804) and configured to cause the processor to receive signaling that indicates a mapping between a set of logical channels and a set of importance values associated with a set of tokens, where the set of tokens is associated with an application, and route a data packet including at least one token of the set of tokens to a logical channel of the set of logical channels based on an importance value associated with the at least one token and the mapping. By receiving the mapping and routing data packets based on token importance values, the processor 800 enables semantic aware transmission that provides differentiated QoS handling for tokens, ensuring that high importance tokens are transmitted via logical channels with more robust transmission parameters, while low importance tokens may be transmitted more efficiently.

Additionally, the processor 800 may be configured to or operable to support any one or combination of to obtain, from the application, data for input to a tokenizer, and generate a token set based on the data, where the token set includes the at least one token, and where the importance value indicates a semantic relevance of the at least one token for reconstruction of the data. By obtaining data from the application and generating token sets with associated importance values indicating semantic relevance, the processor 800 enables the wireless communications system to prioritize transmission resources based on the content of the data. Additionally, or alternatively, the processor 800 may be configured to or operable to support the data packet includes a header that indicates information associated with the token set, and where the information includes one or more of a first sequence number associated with the token set, a second sequence number associated with an initial token in the token set, a third sequence number associated with a final token in the token set, a numerical quantity of tokens within the token set, a numerical quantity of bytes associated with the token set, respective importance values of one or more tokens of the token set, or a minimum numerical quantity of successfully decoded tokens associated with the token set. By including header information associated with the token set, the processor 800 enables the receiving device to efficiently process and reconstruct the transmitted data by providing metadata that facilitates token set identification, boundary detection, and importance aware decoding operations.

Additionally, or alternatively, the processor 800 may be configured to or operable to support at least one of the token set or respective tokens of the token set is associated with one or more of a delay budget or a token error rate, and where the token error rate is based on respective importance values of a subset of tokens of the token set. By associating delay budgets and token error rates with token sets based on importance values, the processor 800 enables fine grained QoS management that accounts for the semantic significance of tokens, ensuring that high importance tokens meet stringent latency and reliability criterion, while improving overall system capacity. Additionally, or alternatively, the processor 800 may be configured to or operable to support to transmit a control data packet including metadata associated with the token set, where the metadata includes one or more of respective first sequence numbers corresponding to one or more first tokens of the token set associated with respective importance values that satisfy a threshold importance value, a second sequence number associated with an initial token in the token set, a third sequence number associated with a final token in the token set, a minimum numerical quantity of successfully decoded tokens associated with the token set, or one or more fourth sequence numbers associated with one or more second tokens of the token set corresponding to the token set being successfully decoded. By transmitting control data packets with token set metadata, the processor 800 enables the receiving device to improve reordering and decoding operations by identifying high importance tokens and determining successful decoding thresholds without waiting for low importance tokens.

Additionally, or alternatively, the processor 800 may be configured to or operable to support to receive additional signaling that indicates to apply, for a radio bearer or at least one logical channel, at least one transmission mode of a set of transmission modes for transmission of a set of data packets including the data packet, where the additional signaling includes a MAC-CE. By receiving transmission mode indications via MAC-CE signaling, the processor 800 enables dynamic adaptation of token transmission strategies based on network conditions and application criterion, providing flexibility to switch between uniform and semantic aware transmission modes. Additionally, or alternatively, the processor 800 may be configured to or operable to support the set of transmission modes includes a first transmission mode that indicates to route the set of data packets to a single logical channel of the set of logical channels and a second transmission mode that indicates to route the set of data packets to the set of logical channels based on the set of importance values. By supporting multiple transmission modes, including single channel routing and importance-based multi-channel routing, the processor 800 provides enhanced semantic aware transmission capabilities when beneficial for token-based communications.

Additionally, or alternatively, the processor 800 may be configured to or operable to support the set of transmission modes includes a transmission mode that indicates to transmit tokens of the set of tokens associated with respective importance values that satisfy a threshold importance value and to discard remaining tokens of the set of tokens. By supporting a transmission mode that selectively transmits high importance tokens and discards low importance tokens, the processor 800 enables efficient utilization of radio resources during congestion or degraded channel conditions, while preserving the ability to reconstruct high importance data at the receiver. Additionally, or alternatively, the processor 800 may be configured to or operable to support the set of transmission modes includes a transmission mode that indicates to apply a set of discard timers to the set of tokens based on respective importance values associated with the set of tokens. By applying importance-based discard timers to tokens, the processor 800 enables time sensitive management of token transmissions, where high importance tokens are retained longer for transmission attempts, while low importance tokens may be discarded sooner to reduce buffer congestion and latency.

Additionally, or alternatively, the processor 800 may be configured to or operable to support to receive additional signaling that enables concatenation of two or more tokens of the set of tokens in the data packet, where the additional signaling includes at least one parameter that indicates the concatenation is enabled, a token size associated with the concatenation, or a maximum numerical quantity of tokens associated with the concatenation, and multiplex, based on the additional signaling, the two or more tokens in the data packet, where the two or more tokens include the at least one token and are associated with the importance value. By enabling concatenation of tokens with the same importance value, the processor 800 reduces protocol overhead and processing complexity associated with transmitting small sized tokens individually. Additionally, or alternatively, the processor 800 may be configured to or operable to support the signaling indicates a range of tags including data packet metadata, where the range of tags is associated with a radio bearer that is mapped to the set of logical channels, and where the data packet is routed within at least one of a PDCP layer or an RLC layer. By utilizing tags for data packet metadata and enabling routing within PDCP or RLC layers, the processor 800 provides flexible implementation options for semantic aware packet distribution that can be adapted to different protocol stack configurations.

Additionally, or alternatively, the processor 800 may be configured to or operable to support to transmit an RLC status report that indicates for one or more tokens of the set of tokens to be retransmitted based on a NACK, where the one or more tokens are associated with one or more importance values of the set of importance values that satisfy a threshold importance value. By transmitting RLC status reports that selectively request retransmission of high importance tokens, the processor 800 enables efficient use of retransmission resources by prioritizing recovery of semantically high importance tokens, while reducing retransmissions of low importance tokens. Additionally, or alternatively, the processor 800 may be configured to or operable to support to generate a TB including the data packet, segment the TB into a set of CBs, where a CB of the set of CBs includes the at least one token, select, for the set of CBs, one or more respective transmission parameters based on respective importance values associated with tokens within the set of CBs, where the one or more respective transmission parameters include an MCS, a HARQ operating point, a maximum numerical quantity of HARQ retransmissions, or an RLC transmission mode, and transmit the TB to an NE based on the one or more respective transmission parameters. By segmenting TBs into CBs aligned with token boundaries and selecting transmission parameters based on token importance, the processor 800 enables high importance tokens to be transmitted with more robust parameters, while improving throughput for low importance tokens.

Additionally, or alternatively, the processor 800 may be configured to or operable to support the signaling includes RRC signaling, and where the data packet includes a header that indicates the importance value. By utilizing RRC signaling for configuration and including importance values in data packet headers, the processor 800 enables standardized configuration of semantic aware transmission parameters and provides explicit importance indication to receiving devices for improved processing. Additionally, or alternatively, the processor 800 may be configured to or operable to support to receive additional signaling that indicates an additional mapping between the set of importance values and a set of maximum retransmission values for an RLC entity, and maintain, for the data packet, a maximum number of RLC retransmissions based on the importance value and the additional mapping. By maintaining importance-based maximum RLC retransmission values, the processor 800 enables differentiated reliability handling at the RLC layer, where high importance tokens receive more retransmission attempts to ensure successful delivery, while low importance tokens are subject to fewer retransmissions to conserve resources. Additionally, or alternatively, the processor 800 may be configured to or operable to support the additional signaling indicates an RLF maximum transmission number threshold associated with the RLC entity, and to trigger an RLF based on an RLC transmission counter satisfying the RLF maximum transmission number threshold. By configuring RLF thresholds in conjunction with importance-based retransmission values, the processor 800 enables RLF detection that accounts for the semantic aware transmission scheme.

The processor 800 may be configured to or operable to support at least one controller (e.g., the controller 802) coupled with at least one memory (e.g., the memory 804) and configured to cause the processor to transmit signaling that indicates a mapping between a set of logical channels and a set of importance values associated with a set of tokens, where the set of tokens is associated with an application, and receive, via a logical channel of the set of logical channels, a data packet including at least one token of the set of tokens based on an importance value associated with the at least one token and the mapping. By transmitting the mapping and receiving data packets via importance-based logical channels, the processor 800 enables network controlled semantic aware communication that allows the network to configure differentiated QoS for tokens based on a semantic relevance, improving overall system efficiency and ensuring reliable delivery of high importance semantic content.

Additionally, the processor 800 may be configured to or operable to support any one or combination of to receive a token set including the at least one token, where the token set represents data, and reconstruct the data based on the token set and one or more importance values associated with respective tokens of the token set, where the one or more importance values indicate a semantic relevance of the respective tokens for reconstruction of the data. By receiving token sets and reconstructing data based on importance values, the processor 800 enables successful data recovery even if some low importance tokens are missing or received with errors, as the importance values guide prioritization of tokens that contribute to reconstruction. Additionally, or alternatively, the processor 800 may be configured to or operable to support the data packet includes a header that indicates information associated with the token set, and where the information includes one or more of a first sequence number associated with the token set, a second sequence number associated with an initial token in the token set, a third sequence number associated with a final token in the token set, a numerical quantity of tokens within the token set, a numerical quantity of bytes associated with the token set, the one or more importance values, or a minimum numerical quantity of successfully decoded tokens associated with the token set. By processing header information associated with token sets, the processor 800 can efficiently identify token set boundaries, determine decoding criterion, and improve reconstruction operations based on the metadata provided in the received data packets.

Additionally, or alternatively, the processor 800 may be configured to or operable to support at least one of the token set or the respective tokens is associated with one or more of a delay budget or a token error rate, and where the token error rate is based on respective importance values of a subset of tokens of the token set. By utilizing delay budgets and importance-based token error rates, the processor 800 enables QoS monitoring and enforcement that accounts for the semantic significance of tokens, ensuring that application layer quality criterion are met for high importance semantic content. Additionally, or alternatively, the processor 800 may be configured to or operable to support to receive a control data packet including metadata associated with the token set, where the metadata includes one or more of respective first sequence numbers corresponding to one or more first tokens of the token set associated with respective importance values that satisfy a threshold importance value, a second sequence number associated with an initial token in the token set, a third sequence number associated with a final token in the token set, a minimum numerical quantity of successfully decoded tokens associated with the token set, or one or more fourth sequence numbers associated with one or more second tokens of the token set corresponding to the token set being successfully decoded. By receiving control data packets with token set metadata, the processor 800 can improve processing operations by identifying high importance tokens for prioritized handling and determining when sufficient tokens have been received for successful data reconstruction.

Additionally, or alternatively, the processor 800 may be configured to or operable to support to transmit, to a UE, additional signaling that indicates for the UE to apply, for a radio bearer or at least one logical channel, at least one transmission mode of a set of transmission modes for transmission of a set of data packets including the data packet, where the additional signaling includes a MAC-CE. By transmitting transmission mode indications via MAC-CE signaling, the processor 800 enables dynamic network control over UE transmission behavior, allowing the network to adapt token transmission strategies based on current network conditions, traffic load, and application criterion. Additionally, or alternatively, the processor 800 may be configured to or operable to support the set of transmission modes includes a first transmission mode that indicates for the UE to route the set of data packets to a single logical channel of the set of logical channels and a second transmission mode that indicates for the UE to route the set of data packets to the set of logical channels based on the set of importance values. By configuring multiple transmission modes for UE operation, the processor 800 provides network flexibility to select between single channel routing and advanced semantic aware multi-channel routing based on system criterion and UE capabilities.

Additionally, or alternatively, the processor 800 may be configured to or operable to support the set of transmission modes includes a transmission mode that indicates for the UE to transmit tokens of the set of tokens associated with respective importance values that satisfy a threshold importance value and to discard remaining tokens of the set of tokens. By configuring selective token transmission modes, the processor 800 enables network controlled resource improvement during congestion scenarios. Additionally, or alternatively, the processor 800 may be configured to or operable to support the set of transmission modes includes a transmission mode that indicates for the UE to apply a set of discard timers to the set of tokens based on respective importance values associated with the set of tokens. By configuring importance-based discard timers for UE operation, the processor 800 enables network control over time sensitive token management that ensures high importance tokens are prioritized for transmission, while preventing excessive buffering of low importance tokens.

Additionally, or alternatively, the processor 800 may be configured to or operable to support to transmit, to a UE, additional signaling that enables, at the UE, concatenation of two or more tokens of the set of tokens in the data packet, where the additional signaling includes at least one parameter that indicates the concatenation is enabled, a token size associated with the concatenation, or a maximum numerical quantity of tokens associated with the concatenation, and receive, based on the additional signaling, the two or more tokens multiplexed in the data packet, where the two or more tokens include the at least one token and are associated with the importance value. By enabling and configuring token concatenation at the UE, the processor 800 reduces protocol overhead and improves transmission efficiency for small sized tokens, while maintaining network control over concatenation parameters to ensure compatibility with receiver processing capabilities. Additionally, or alternatively, the processor 800 may be configured to or operable to support the signaling indicates a range of tags including data packet metadata, where the range of tags is associated with a radio bearer that is mapped to the set of logical channels, and where the data packet is routed within at least one of a PDCP layer or an RLC layer. By configuring tag ranges for data packet metadata, the processor 800 enables standardized identification of token importance levels within the protocol stack, facilitating consistent semantic aware routing across different implementation configurations.

Additionally, or alternatively, the processor 800 may be configured to or operable to support to receive an RLC status report that indicates for one or more tokens of the set of tokens to be retransmitted based on a NACK, where the one or more tokens are associated with one or more importance values of the set of importance values that satisfy a threshold importance value. By receiving RLC status reports with importance aware retransmission requests, the processor 800 can efficiently schedule retransmissions that prioritize recovery of high importance tokens. Additionally, or alternatively, the processor 800 may be configured to or operable to support to receive, from a UE, a TB including the data packet, where the TB includes a set of CBs associated with one or more respective transmission parameters that are based on respective importance values associated with tokens within the set of CBs, where the one or more respective transmission parameters include an MCS, a HARQ operating point, a maximum numerical quantity of HARQ retransmissions, or an RLC transmission mode. By receiving TBs with importance-based CB configurations, the processor 800 can perform differentiated decoding and error handling that accounts for the varying reliability criterion of tokens with different semantic importance levels.

Additionally, or alternatively, the processor 800 may be configured to or operable to support the signaling includes RRC signaling, and where the data packet includes a header that indicates the importance value. By utilizing RRC signaling for configuration and processing importance values from data packet headers, the processor 800 enables standardized semantic aware communication that provides explicit importance indication for improved network side processing and resource allocation. Additionally, or alternatively, the processor 800 may be configured to or operable to support to transmit additional signaling that indicates an additional mapping between the set of importance values and a set of maximum retransmission values for an RLC entity, where the additional signaling indicates an RLF maximum transmission number threshold associated with the RLC entity. By configuring importance-based RLC retransmission mappings and RLF thresholds, the processor 800 enables network control over differentiated reliability handling that ensures high importance tokens receive retransmission attempts, while maintaining RLF detection for overall link quality management.

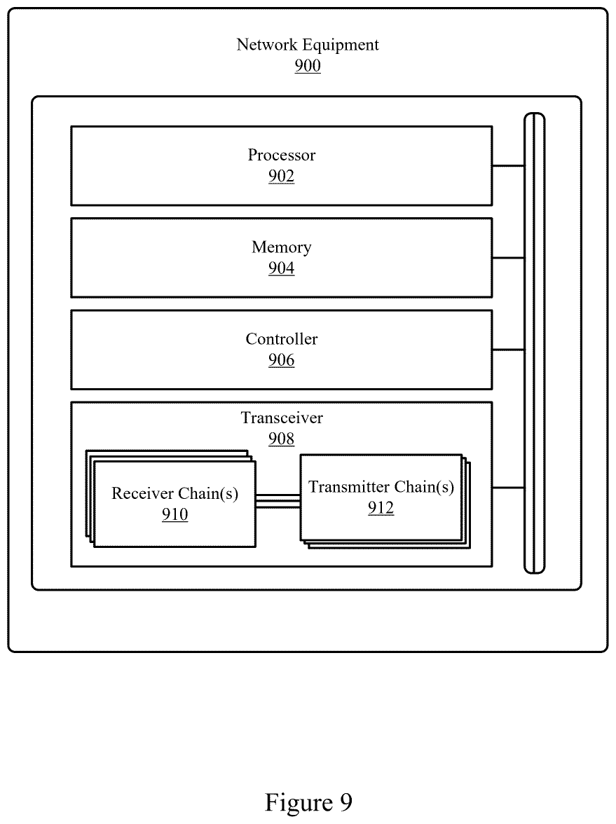

FIG. 9 illustrates an example of an NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to or operable to support a means for transmitting signaling that indicates a mapping between a set of logical channels and a set of importance values associated with a set of tokens, where the set of tokens is associated with an application, and receiving, via a logical channel of the set of logical channels, a data packet including at least one token of the set of tokens based on an importance value associated with the at least one token and the mapping. By transmitting the mapping and receiving data packets via importance-based logical channels, the NE 900 enables network controlled semantic aware communication that allows the network to configure differentiated QoS for tokens based on a semantic relevance, improving overall system efficiency and ensuring reliable delivery of high importance semantic content while reducing latency for semantically relevant tokens by prioritizing transmission for tokens with importance values that satisfy a threshold value.

Additionally, the NE 900 may be configured to or operable to support any one or combination of to receive a token set including the at least one token, where the token set represents data, and reconstruct the data based on the token set and one or more importance values associated with respective tokens of the token set, where the one or more importance values indicate a semantic relevance of the respective tokens for reconstruction of the data. By receiving token sets and reconstructing data based on importance values, the NE 900 enables successful data recovery even if some low importance tokens are missing or received with errors, as the importance values guide prioritization of tokens that contribute to reconstruction. Additionally, or alternatively, the NE 900 may be configured to or operable to support the data packet includes a header that indicates information associated with the token set, and where the information includes one or more of a first sequence number associated with the token set, a second sequence number associated with an initial token in the token set, a third sequence number associated with a final token in the token set, a numerical quantity of tokens within the token set, a numerical quantity of bytes associated with the token set, the one or more importance values, or a minimum numerical quantity of successfully decoded tokens associated with the token set. By processing header information associated with token sets, the NE 900 can efficiently identify token set boundaries, determine decoding criterion, and improve reconstruction operations based on the metadata provided in the received data packets.

Additionally, or alternatively, the NE 900 may be configured to or operable to support at least one of the token set or the respective tokens is associated with one or more of a delay budget or a token error rate, and where the token error rate is based on respective importance values of a subset of tokens of the token set. By utilizing delay budgets and importance-based token error rates, the NE 900 enables QoS monitoring and enforcement that accounts for the semantic significance of tokens, ensuring that application layer quality criterion are met for semantic content, while allowing more efficient transmission of less important tokens. Additionally, or alternatively, the NE 900 may be configured to or operable to support to receive a control data packet including metadata associated with the token set, where the metadata includes one or more of respective first sequence numbers corresponding to one or more first tokens of the token set associated with respective importance values that satisfy a threshold importance value, a second sequence number associated with an initial token in the token set, a third sequence number associated with a final token in the token set, a minimum numerical quantity of successfully decoded tokens associated with the token set, or one or more fourth sequence numbers associated with one or more second tokens of the token set corresponding to the token set being successfully decoded. By receiving control data packets with token set metadata, the NE 900 can improve processing operations by identifying high importance tokens for prioritized handling and determining when sufficient tokens have been received for successful data reconstruction, enabling improved reordering processes where the receiver may not wait for low importance tokens before delivering high important tokens to higher layers. Additionally, or alternatively, the NE 900 may be configured to or operable to support to transmit, to a UE, additional signaling that indicates for the UE to apply, for a radio bearer or at least one logical channel, at least one transmission mode of a set of transmission modes for transmission of a set of data packets including the data packet, where the additional signaling includes a MAC-CE. By transmitting transmission mode indications via MAC-CE signaling, the NE 900 enables dynamic network control over UE transmission behavior, allowing the network to adapt token transmission strategies based on current network conditions, traffic load, and application criterion, thereby providing flexibility to switch between legacy-compatible operation and semantic aware transmission.

Additionally, or alternatively, the NE 900 may be configured to or operable to support the set of transmission modes includes a first transmission mode that indicates for the UE to route the set of data packets to a single logical channel of the set of logical channels and a second transmission mode that indicates for the UE to route the set of data packets to the set of logical channels based on the set of importance values. By configuring multiple transmission modes for UE operation, the NE 900 provides network flexibility to select between single channel routing and advanced semantic aware multi-channel routing based on system criterion and UE capabilities, enabling backward compatibility, while supporting enhanced token-based communication for capable devices. Additionally, or alternatively, the NE 900 may be configured to or operable to support the set of transmission modes includes a transmission mode that indicates for the UE to transmit tokens of the set of tokens associated with respective importance values that satisfy a threshold importance value and to discard remaining tokens of the set of tokens. By configuring selective token transmission modes, the NE 900 enables network controlled resource optimization during congestion scenarios where the network can instruct UEs to prioritize transmission of semantically high importance tokens, while discarding less important tokens to maintain system capacity.

Additionally, or alternatively, the NE 900 may be configured to or operable to support the set of transmission modes includes a transmission mode that indicates for the UE to apply a set of discard timers to the set of tokens based on respective importance values associated with the set of tokens. By configuring importance-based discard timers for UE operation, the NE 900 enables network control over time-sensitive token management that ensures high importance tokens are prioritized for transmission, while preventing excessive buffering of low importance tokens. Additionally, or alternatively, the NE 900 may be configured to or operable to support to transmit, to a UE, additional signaling that enables, at the UE, concatenation of two or more tokens of the set of tokens in the data packet, where the additional signaling includes at least one parameter that indicates the concatenation is enabled, a token size associated with the concatenation, or a maximum numerical quantity of tokens associated with the concatenation, and receive, based on the additional signaling, the two or more tokens multiplexed in the data packet, where the two or more tokens include the at least one token and are associated with the importance value. By enabling and configuring token concatenation at the UE, the NE 900 reduces protocol overhead and improves transmission efficiency for small sized tokens, while maintaining network control over concatenation parameters to ensure compatibility with receiver processing capabilities.

Additionally, or alternatively, the NE 900 may be configured to or operable to support the signaling indicates a range of tags including data packet metadata, where the range of tags is associated with a radio bearer that is mapped to the set of logical channels, and where the data packet is routed within at least one of a PDCP layer or an RLC layer. By configuring tag ranges for data packet metadata, the NE 900 enables standardized identification of token importance levels within the protocol stack, facilitating consistent semantic aware routing across different implementation configurations and enabling the routing functionality to operate at different protocol layers. Additionally, or alternatively, the NE 900 may be configured to or operable to support to receive an RLC status report that indicates for one or more tokens of the set of tokens to be retransmitted based on a NACK, where the one or more tokens are associated with one or more importance values of the set of importance values that satisfy a threshold importance value. By receiving RLC status reports with importance aware retransmission requests, the NE 900 can efficiently schedule retransmissions that prioritize recovery of high importance tokens.

Additionally, or alternatively, the NE 900 may be configured to or operable to support to receive, from a UE, a TB including the data packet, where the TB includes a set of CBs associated with one or more respective transmission parameters that are based on respective importance values associated with tokens within the set of CBs, where the one or more respective transmission parameters include an MCS, a HARQ operating point, a maximum numerical quantity of HARQ retransmissions, or an RLC transmission mode. By receiving TBs with importance-based CB configurations, the NE 900 can perform differentiated decoding and error handling that accounts for the varying reliability criterion of tokens with different semantic importance levels. Additionally, or alternatively, the NE 900 may be configured to or operable to support the signaling includes RRC signaling, and where the data packet includes a header that indicates the importance value. By utilizing RRC signaling for configuration and processing importance values from data packet headers, the NE 900 enables standardized semantic aware communication that provides explicit importance indication for improved processing and resource allocation. Additionally, or alternatively, the NE 900 may be configured to or operable to support to transmit additional signaling that indicates an additional mapping between the set of importance values and a set of maximum retransmission values for an RLC entity, where the additional signaling indicates an RLF maximum transmission number threshold associated with the RLC entity. By configuring importance-based RLC retransmission mappings and RLF thresholds, the NE 900 enables network control over differentiated reliability handling that ensures high importance tokens receive retransmission attempts, while maintaining RLF detection for overall link quality management.

Additionally, or alternatively, the NE 900 may support at least one memory (e.g., the memory 904) and at least one processor (e.g., the processor 902) coupled with the at least one memory and configured to cause the NE to transmit signaling that indicates a mapping between a set of logical channels and a set of importance values associated with a set of tokens, where the set of tokens is associated with an application, and receive, via a logical channel of the set of logical channels, a data packet including at least one token of the set of tokens based on an importance value associated with the at least one token and the mapping.

Additionally, the NE 900 may be configured to support any one or combination of to receive a token set including the at least one token, where the token set represents data, and reconstruct the data based on the token set and one or more importance values associated with respective tokens of the token set, where the one or more importance values indicate a semantic relevance of the respective tokens for reconstruction of the data. Additionally, or alternatively, the NE 900 may be configured to or operable to support the data packet includes a header that indicates information associated with the token set, and where the information includes one or more of a first sequence number associated with the token set, a second sequence number associated with an initial token in the token set, a third sequence number associated with a final token in the token set, a numerical quantity of tokens within the token set, a numerical quantity of bytes associated with the token set, the one or more importance values, or a minimum numerical quantity of successfully decoded tokens associated with the token set. Additionally, or alternatively, the NE 900 may be configured to or operable to support at least one of the token set or the respective tokens is associated with one or more of a delay budget or a token error rate, and where the token error rate is based on respective importance values of a subset of tokens of the token set. Additionally, or alternatively, the NE 900 may be configured to or operable to support to receive a control data packet including metadata associated with the token set, where the metadata includes one or more of respective first sequence numbers corresponding to one or more first tokens of the token set associated with respective importance values that satisfy a threshold importance value, a second sequence number associated with an initial token in the token set, a third sequence number associated with a final token in the token set, a minimum numerical quantity of successfully decoded tokens associated with the token set, or one or more fourth sequence numbers associated with one or more second tokens of the token set corresponding to the token set being successfully decoded.

Additionally, or alternatively, the NE 900 may be configured to or operable to support to transmit, to a UE, additional signaling that indicates for the UE to apply, for a radio bearer or at least one logical channel, at least one transmission mode of a set of transmission modes for transmission of a set of data packets including the data packet, where the additional signaling includes a MAC-CE. Additionally, or alternatively, the NE 900 may be configured to or operable to support the set of transmission modes includes a first transmission mode that indicates for the UE to route the set of data packets to a single logical channel of the set of logical channels and a second transmission mode that indicates for the UE to route the set of data packets to the set of logical channels based on the set of importance values. Additionally, or alternatively, the NE 900 may be configured to or operable to support the set of transmission modes includes a transmission mode that indicates for the UE to transmit tokens of the set of tokens associated with respective importance values that satisfy a threshold importance value and to discard remaining tokens of the set of tokens. Additionally, or alternatively, the NE 900 may be configured to or operable to support the set of transmission modes includes a transmission mode that indicates for the UE to apply a set of discard timers to the set of tokens based on respective importance values associated with the set of tokens.

Additionally, or alternatively, the NE 900 may be configured to or operable to support to transmit, to a UE, additional signaling that enables, at the UE, concatenation of two or more tokens of the set of tokens in the data packet, where the additional signaling includes at least one parameter that indicates the concatenation is enabled, a token size associated with the concatenation, or a maximum numerical quantity of tokens associated with the concatenation, and receive, based on the additional signaling, the two or more tokens multiplexed in the data packet, where the two or more tokens include the at least one token and are associated with the importance value. Additionally, or alternatively, the NE 900 may be configured to or operable to support the signaling indicates a range of tags including data packet metadata, where the range of tags is associated with a radio bearer that is mapped to the set of logical channels, and where the data packet is routed within at least one of a PDCP layer or an RLC layer. Additionally, or alternatively, the NE 900 may be configured to or operable to support to receive an RLC status report that indicates for one or more tokens of the set of tokens to be retransmitted based on a NACK, where the one or more tokens are associated with one or more importance values of the set of importance values that satisfy a threshold importance value.

Additionally, or alternatively, the NE 900 may be configured to or operable to support to receive, from a UE, a TB including the data packet, where the TB includes a set of CBs associated with one or more respective transmission parameters that are based on respective importance values associated with tokens within the set of CBs, where the one or more respective transmission parameters include an MCS, a HARQ operating point, a maximum numerical quantity of HARQ retransmissions, or an RLC transmission mode. Additionally, or alternatively, the NE 900 may be configured to or operable to support the signaling includes RRC signaling, and where the data packet includes a header that indicates the importance value. Additionally, or alternatively, the NE 900 may be configured to or operable to support to transmit additional signaling that indicates an additional mapping between the set of importance values and a set of maximum retransmission values for an RLC entity, where the additional signaling indicates an RLF maximum transmission number threshold associated with the RLC entity.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., an LNA) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

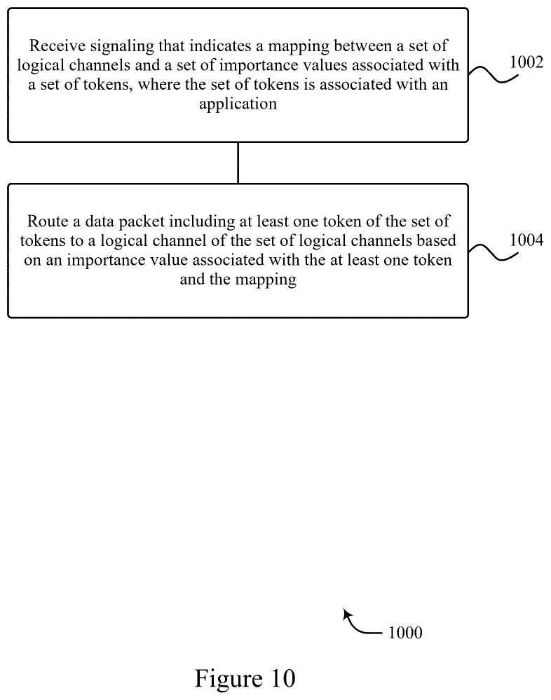

FIG. 10 illustrates a flowchart of a method 1000 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1002, the method may include receiving signaling that indicates a mapping between a set of logical channels and a set of importance values associated with a set of tokens, where the set of tokens is associated with an application. The operations of 1002 may be performed in accordance with examples as described herein. In some implementations, aspects of the operations of 1002 may be performed by a UE as described with reference to FIG. 7.

At 1004, the method may include routing a data packet including at least one token of the set of tokens to a logical channel of the set of logical channels based on an importance value associated with the at least one token and the mapping. The operations of 1004 may be performed in accordance with examples as described herein. In some implementations, aspects of the operations of 1004 may be performed by a UE as described with reference to FIG. 7.

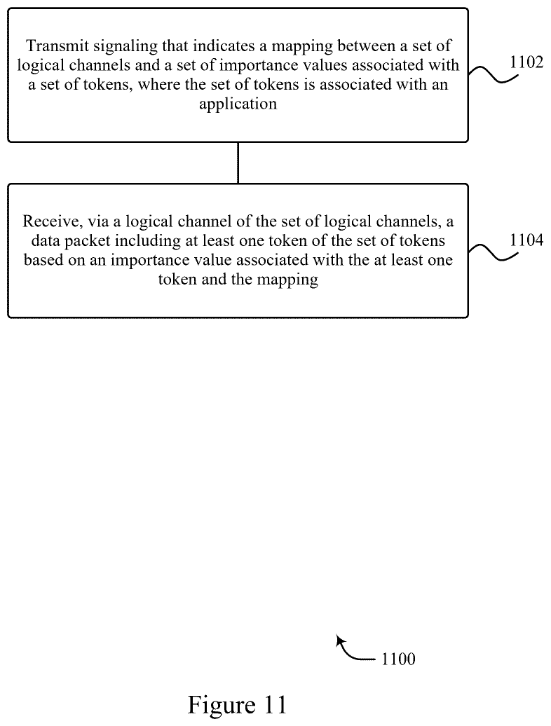

FIG. 11 illustrates a flowchart of a method 1100 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include transmitting signaling that indicates a mapping between a set of logical channels and a set of importance values associated with a set of tokens, where the set of tokens is associated with an application. The operations of 1102 may be performed in accordance with examples as described herein. In some implementations, aspects of the operations of 1102 may be performed by an NE as described with reference to FIG. 9.

At 1104, the method may include receiving, via a logical channel of the set of logical channels, a data packet including at least one token of the set of tokens based on an importance value associated with the at least one token and the mapping. The operations of 1104 may be performed in accordance with examples as described herein. In some implementations, aspects of the operations of 1104 may be performed by an NE as described with reference to FIG. 9.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive signaling that indicates a mapping between a plurality of logical channels and a set of importance values associated with a plurality of tokens, wherein the plurality of tokens is associated with an application; and
route a data packet comprising at least one token of the plurality of tokens to a logical channel of the plurality of logical channels based at least in part on an importance value associated with the at least one token and the mapping.

2. The UE of claim 1, wherein to route the data packet, the at least one processor is operable to cause the UE to:
obtain, from the application, data for input to a tokenizer; and
generate a token set based at least in part on the data, wherein the token set comprises the at least one token, and wherein the importance value indicates a semantic relevance of the at least one token for reconstruction of the data.

3. The UE of claim 2, wherein the data packet comprises a header that indicates information associated with the token set, and wherein the information comprises one or more of a first sequence number associated with the token set, a second sequence number associated with an initial token in the token set, a third sequence number associated with a final token in the token set, a numerical quantity of tokens within the token set, a numerical quantity of bytes associated with the token set, respective importance values of one or more tokens of the token set, or a minimum numerical quantity of successfully decoded tokens associated with the token set.

4. The UE of claim 2, wherein at least one of the token set or respective tokens of the token set is associated with one or more of a delay budget or a token error rate, and wherein the token error rate is based at least in part on respective importance values of a subset of tokens of the token set.

5. The UE of claim 2, wherein the at least one processor is further operable to cause the UE to transmit a control data packet comprising metadata associated with the token set, wherein the metadata comprises one or more of respective first sequence numbers corresponding to one or more first tokens of the token set associated with respective importance values that satisfy a threshold importance value, a second sequence number associated with an initial token in the token set, a third sequence number associated with a final token in the token set, a minimum numerical quantity of successfully decoded tokens associated with the token set, or one or more fourth sequence numbers associated with one or more second tokens of the token set corresponding to the token set being successfully decoded.

6. The UE of claim 1, wherein the at least one processor is further operable to cause the UE to receive additional signaling that indicates to apply, for a radio bearer or at least one logical channel, at least one transmission mode of a plurality of transmission modes for transmission of a plurality of data packets comprising the data packet, wherein the additional signaling comprises a medium access control-control element (MAC-CE).

7. The UE of claim 6, wherein the plurality of transmission modes comprises a first transmission mode that indicates to route the plurality of data packets to a single logical channel of the plurality of logical channels and a second transmission mode that indicates to route the plurality of data packets to the plurality of logical channels based at least in part on the set of importance values.

8. The UE of claim 6, wherein the plurality of transmission modes comprises a transmission mode that indicates to transmit tokens of the plurality of tokens associated with respective importance values that satisfy a threshold importance value and to discard remaining tokens of the plurality of tokens.

9. The UE of claim 6, wherein the plurality of transmission modes comprises a transmission mode that indicates to apply a plurality of discard timers to the plurality of tokens based at least in part on respective importance values associated with the plurality of tokens.

10. The UE of claim 1, wherein the at least one processor is further operable to cause the UE to:
receive additional signaling that enables concatenation of two or more tokens of the plurality of tokens in the data packet, wherein the additional signaling comprises at least one parameter that indicates the concatenation is enabled, a token size associated with the concatenation, or a maximum numerical quantity of tokens associated with the concatenation; and
multiplex, based at least in part on the additional signaling, the two or more tokens in the data packet, wherein the two or more tokens comprise the at least one token and are associated with the importance value.

11. The UE of claim 1, wherein the signaling indicates a range of tags comprising data packet metadata, wherein the range of tags is associated with a radio bearer that is mapped to the plurality of logical channels, and wherein the data packet is routed within at least one of a packet data convergence protocol (PDCP) layer or a radio link control (RLC) layer.

12. The UE of claim 1, wherein the at least one processor is further operable to cause the UE to transmit a radio link control (RLC) status report that indicates for one or more tokens of the plurality of tokens to be retransmitted based at least in part on a negative acknowledgement (NACK), wherein the one or more tokens are associated with one or more importance values of the set of importance values that satisfy a threshold importance value.

13. The UE of claim 1, wherein the at least one processor is further operable to cause the UE to:
generate a transport block (TB) comprising the data packet, wherein the data packet comprises a header that indicates the importance value;
segment the transport block into a plurality of code blocks (CBs), wherein a CB of the plurality of CBs comprises the at least one token;
select, for the plurality of CBs, one or more respective transmission parameters based at least in part on respective importance values associated with tokens within the plurality of CBs, wherein the one or more respective transmission parameters comprise a modulation and coding scheme (MCS), a hybrid automatic repeat request (HARQ) operating point, a maximum numerical quantity of HARQ retransmissions, or a radio link control (RLC) transmission mode; and
transmit the TB to a network equipment (NE) based at least in part on the one or more respective transmission parameters.

14. The UE of claim 1, wherein the at least one processor is further operable to cause the UE to:
receive additional signaling that indicates an additional mapping between the set of importance values and a plurality of maximum retransmission values for a radio link control (RLC) entity, wherein the additional signaling indicates a radio link failure (RLF) maximum transmission number threshold associated with the RLC entity;
maintain, for the data packet, a maximum number of RLC retransmissions based at least in part on the importance value and the additional mapping; and
trigger an RLF based at least in part on an RLC transmission counter satisfying the RLF maximum transmission number threshold.

15. A method performed by a user equipment (UE), the method comprising:
receiving signaling that indicates a mapping between a plurality of logical channels and a set of importance values associated with a plurality of tokens, wherein the plurality of tokens is associated with an application; and
routing a data packet comprising at least one token of the plurality of tokens to a logical channel of the plurality of logical channels based at least in part on an importance value associated with the at least one token and the mapping.

16. A network equipment (NE) for wireless communication, comprising:
at least one memory; and
at least one processor coupled with the at least one memory and operable to cause the NE to:
transmit signaling that indicates a mapping between a plurality of logical channels and a set of importance values associated with a plurality of tokens, wherein the plurality of tokens is associated with an application; and
receive, via a logical channel of the plurality of logical channels, a data packet comprising at least one token of the plurality of tokens based at least in part on an importance value associated with the at least one token and the mapping.

17. The NE of claim 16, wherein to receive the data packet, the at least one processor is further operable to cause the NE to:
receive a token set comprising the at least one token, wherein the token set represents data; and
reconstruct the data based at least in part on the token set and one or more importance values associated with respective tokens of the token set, wherein the one or more importance values indicate a semantic relevance of the respective tokens for reconstruction of the data.

18. The NE of claim 16, wherein the at least one processor is further operable to cause the NE to transmit, to a user equipment (UE), additional signaling that indicates for the UE to apply, for a radio bearer or at least one logical channel, at least one transmission mode of a plurality of transmission modes for transmission of a plurality of data packets comprising the data packet, wherein the additional signaling comprises a medium access control-control element (MAC-CE).

19. The NE of claim 16, wherein the at least one processor is further operable to cause the NE to:
transmit, to a user equipment (UE), additional signaling that enables, at the UE, concatenation of two or more tokens of the plurality of tokens in the data packet, wherein the additional signaling comprises at least one parameter that indicates the concatenation is enabled, a token size associated with the concatenation, or a maximum numerical quantity of tokens associated with the concatenation; and
receive, based at least in part on the additional signaling, the two or more tokens multiplexed in the data packet, wherein the two or more tokens comprise the at least one token and are associated with the importance value.

20. A method performed by a network equipment (NE), the method comprising:
transmitting signaling that indicates a mapping between a plurality of logical channels and a set of importance values associated with a plurality of tokens, wherein the plurality of tokens is associated with an application; and
receiving, via a logical channel of the plurality of logical channels, a data packet comprising at least one token of the plurality of tokens based at least in part on an importance value associated with the at least one token and the mapping.
